(19) United States
(12) Patent Application Publication
(10) Pub. No.: US 2018/0211793 A1
(43) Pub. Date: Jul. 26, 2018

(54) Carbon-Containing Composites and Electrodes

(71) Applicant: Cambridge Enterprise Limited, Cambridge, Cambridgeshire (GB)

(72) Inventors: Dona Galhena, Cambridge (GB); Gehan Amaratunga, Cambridge (GB); Stephan Hofmann, Cambridge (GB)

(21) Appl. No.: 15/747,727

(22) PCT Filed: Jul. 29, 2016
(86) PCT No.: PCT/GB2016/052336

§ 371 Date: Jan. 25, 2018

(30) Foreign Application Priority Data
Jul. 31, 2015 (GB) 1513603.9

(51) Int. Cl. H01G 11/34; H01G 11/86; H01G 11/36; H01G 11/28; C01B 32/23

(52) U.S. Cl. CPC H01G 11/34; H01G 11/86; C01B 32/23; H01G 11/28; H01G 11/36

(57) ABSTRACT

The invention provides a method for preparing a carbon composite, the method comprising the step of heating a mixture of graphene oxide and an active material, such as a carbon active material, such as activated carbon, at a temperature in the range 200 to 650° C., such as about 300° C. Also provided is the carbon composite obtained or obtainable from the method. The carbon composition may be provided on a backing plate, such as an electrically conductive backing plate. The carbon composite may be a component, such as the electrode, of a capacitor, such as a supercapacitor, and also provided are methods for charging and discharging the supercapacitor comprising the carbon composite.

### RELATED APPLICATION

The present case claims priority to, and the benefit of, GB 1513603.9 filed on 31 Jul. 2015, the contents of which are hereby incorporated by reference in their entirety.

### FIELD OF THE INVENTION

The present invention provides carbon-containing electrodes for use in supercapacitors, methods for preparing the electrodes, and supercapacitors comprising such electrodes.

Also provided are methods for charging and discharging supercapacitors comprising carbon-containing electrodes. A further aspect of the invention provides a carbon-containing composite for use in a carbon-containing electrode.

### BACKGROUND

Supercapacitors are highly desirable in electrical applications where high power density and long cycle life are required. As such supercapacitors may complement or even replace traditional batteries in these applications.

Supercapacitors, also called electrical double-layer (EDL) or ultracapacitors, are electrochemical devices which store energy through reversible adsorption of ionic species onto electrode surfaces. Compared with conventional capacitors, supercapacitors have energy densities that are several orders of magnitude higher (hence the ‘super’ or ‘ultra’ prefix). Supercapacitors also have a higher power density than most batteries, but their energy density is somewhat lower. In addition, due to their highly reversible charge storage process, supercapacitors have longer cycle-lives. Through appropriate cell design, both the energy density and power density ranges for supercapacitors can cover several orders of magnitude and this makes them extremely versatile as a stand-alone energy supply, or in combination with batteries as a hybrid system. To date, considerable research is presently being directed towards the development of supercapacitors with the overall goals of increasing energy density with minimum sacrifice in power density and cycle life.

A supercapacitor has two opposing electrodes immersed in an electrolyte with an ion permeable separator placed between the electrodes. An electrode of a supercapacitor is generally prepared by, for example, mixing an active material together with a binder in a solvent, optionally together with other additives such as conductive additives. The mixture is coated onto a current collector, and then dried. The resulting electrode has a layer of material across a surface of the collector.

Traditionally the electrodes for use in supercapacitors have been based on activated carbon. This carbon provides a good balance between material cost and electrical performance. However, there is considerable scope to improve the performance of activated carbon-based electrodes. For example, there is a desire to improve the specific capacitance of the electrode, together with the conductivity of the electrode.

Recent work in the field of supercapacitors has therefore looked at developing the carbon electrode material with a view to reducing internal resistance and increasing capacitance retention performance.

For example, Yan et al. describe the preparation of a carbon electrode that is a graphene-MnO₂ composite (Yan et al. Carbon 2010, 48, 3825). Here, the composite is prepared by redox reaction between graphene and potassium permanganate under microwave irradiation. The as-prepared material was mixed with a conductive additive carbon black and a binder poly(tetrafluoroethylene) (PTFE) and dispersed in ethanol. Then the resulting mixture was coated onto the nickel foam substrate. The composite is said to have an overall specific capacitance of 310 F/g at 2 mV/s.

In a similar approach, Wang et al. describe the preparation of a carbon electrode that is a graphene-Mn₃O₄ composite (Wang et al. Electrochimica Acta 2010, 55, 6812). In this work an organosol was prepared containing MnO₂ which was mixed with a graphene suspension. MnO₂ nanoparticles and graphene nanosheets were permitted to precipitate. Heat treatment of the mixture converts MnO₂ to Mn₃O₄. The electrodes was prepared by mixing Mn₃O₄/graphene powders with polyvinylidene difluoride (PVdF) binder in the presence of N-methyl pyrrolidinone (NMP). The resulting slurry was pasted on platinum foil. The composite is said to have an overall specific capacitance of 175 F/g at 5 mV/s.

Zhu et al. describe the preparation of a carbon electrode that is based on reduced graphene oxide and NiO (Zhu et al. Electrochimica Acta 2012, 64, 23). The composite was prepared by homogeneous coprecipitation followed by reduction with hydrazine at elevated temperatures. The electrode was prepared from the composite together with a polytetrafluoroethylene binder.

US 2014/0340818 describes supercapacitors having a porous carbonaceous material such as graphene into which a metal oxide is deposited.

Yu et al. have described the preparation of carbon composites from graphene nanosheets and potassium hydroxide-activated carbon (see Yu et al. RSC Adv. 2014, 4, 48758). The graphene nanosheets are obtained by thermal treatment of graphene oxide in the presence of the potassium hydroxide-activated carbon. The mixture of nanosheets and activated carbon is heated at a temperature of 180° C. for 12 h.

Yu et al. describe the preparation of electrodes using the carbon composite together with an organic polymer binder (polyvinylidene fluoride, present at 5 wt %) and conductive carbon black (present at 10 wt %). The mixture of components was provided onto the surface of an Al foil backing plate and heated to dryness under vacuum.

US 2012/0321953 describes a composite material composed of a graphene derivative (including graphene oxide) with vanadium oxide as the active material.

CN 103515605 describes a method for making a composite material composed of graphene oxide and lithium vanadium phosphate as the active material.

WO 2012/155196 describes a method for producing a composite material composed of graphene oxide and another precursor material. The worked examples make use of cobalt and nickel oxides as precursor materials. The composite is prepared by “spray pyrolysis” method: the components are introduced into a furnace as a spray.

US 2014/0183415 describes a composite material composed of graphene and a “structure former”, which may be either a metal oxide or is formed from a carbon compound. Here, a “carbon precursor” is mixed with the graphene (or precursor graphene oxide). On heating, this precursor is carbonised to produce a carbon layer in the composite material. Example carbon precursors include sucrose, butanol and naphthalene.

CN 103794379 describes a method for preparing a composite material composed of graphene and carbon nanotubes. The method includes a step of heating a mixture of graphene oxide and carbon nanotubes. The mixture is heated in the range 500-700° C.

CN 104064755 describes a method for preparing a composite material composed of graphene, cobalt oxide and carbon nanotubes. In the worked examples, a mixture containing graphene oxide and carbon nanotubes is heated from room temperature to 500-700° C. at a specified heating rate.

CN 103275368 describes a method for preparing a composite material composed of graphene oxide, silica and styrene-butadiene rubber. The use of the composite in a capacitor is not described.

The present inventors have previously described carbon electrodes for use in supercapacitors by way of an abstract and a poster at the Graphene 2014 (Toulouse, France) on 6 May 2014. The contents of the abstract and the poster are incorporated by reference herein.

The inventors' earlier work does not disclose the reaction methods that are essential for the preparation of a carbon composite for use in an electrode.

### SUMMARY OF THE INVENTION

The present invention generally provides a carbon composite comprising reduced graphene oxide and an active material, such as a carbon active material, such as activated carbon. The reduced graphene oxide has binding properties which allows adhesion of the composite to a backing plate, and also ensures that the active material is bound within the composite.

The composite is obtained and obtainable from a reduction of a mixture comprising graphene oxide and the active material, such as a mixture of graphene oxide and the active material provided on a backing plate. The reduction of the graphene oxide may be performed under controlled conditions that minimise uncontrolled thermal expansion of the product composite. The controlled thermal reduction also ensures that the composite maintains its adherence properties, and accordingly the composite may be adhered to a backing plate, such as a current collector.

The carbon composites of the invention have a higher specific capacitance, a high energy density and a high power density, for example when compared with traditional carbon composites for use in supercapacitors.

Thus, in a first aspect of the invention there is provided a method for preparing a carbon composite, the method comprising the step of heating a mixture of graphene oxide and an active material, such as a carbon active material, such as activated carbon, at a temperature in the range 200 to 650° C.

The present inventors have established that at temperatures greater than 650° C. the composite loses its adherence properties and it is not possible to retain the composite on the backing plate. Indeed the reaction temperature may be limited to 450° C. or less, such as 400° C. or less to avoid this problem. At temperatures below 200° C., the reduction reaction does not substantially proceed and the reduction level of the graphene oxide is therefore low. The product has a correspondingly low conductivity.

In one embodiment, the thermal reduction is performed at a temperature within the range 200 to 450° C., such as 250 to 350° C., for example at about 300° C.

Yu et al. describe the reparation of composites by heat treatment of a mixture of graphene oxide with KOH-activated carbon. However, the heating temperature was only 180° C. At such a temperature the product is expected to have a poor conductivity, as the amount of reduced graphene oxide is low.

CN 103794379 and CN 104064755 describe heating graphene-based composites at a temperature in the range 500-700° C. At such temperatures the product has a reduced adherence and the thermal expansion of the composite is not minimised.

The inventors have also found that extended thermal reduction times increase the risk of thermal expansion within the composite. Accordingly, the thermal reduction time is at most 4 hours, such as at most 1 hour. Where the thermal reduction time is greater than 4 hours, there is a noticeable loss in the adherence properties of the composite.

The work of Yu et al. involves the heat treatment of graphene oxide with KOH activated carbon for 12 hours. Such an extended treatment will inevitably reduce the binding properties of the resulting composite. Indeed, where Yu et al. prepare an electrode having the composite on a backing plate an organic polymer binder is provided as an additional component.

The composite may be obtained from a mixture of graphene oxide and an active material, such as a carbon active material, such as activated carbon, where the weight ratios of the graphene oxide and the active material are within certain limits. The inventors have found that both high and low levels of reduced graphene oxide in the composition reduce the specific capacitance of the composite. Accordingly high and low levels graphene oxide are to be avoided in the mixture of graphene oxide and the active material.

Accordingly, in a second aspect of the invention there is provided a method for preparing a carbon composite, the method comprising the step of heating a mixture of graphene oxide and an active material, such as activated carbon, where the weight ratio of graphene oxide to active material is in the range 10:1 to 1:50.

In one embodiment, the weight ratio of graphene oxide to active material is in the range 1:1 to 1:25, such as 1:2 to 1:25, such as 1:5 to 1:15. The weight ratio of graphene oxide to active material may be about 1:10.

In one embodiment, the composition is provided on a backing plate. In one embodiment, the composition is substantially free of an organic polymer binder.

In a third aspect of the invention there is provided a carbon composite obtained or obtainable from the methods of the first or second aspects of the invention.

In one embodiment, the composite is provided on a backing plate, such as a current collector.

In a fourth aspect of the invention there is provided an electrode comprising the carbon composite of the third aspect.

In a fifth aspect of the present invention there is provided a capacitor, such as a supercapacitor, comprising an electrode, such as two electrodes, of the fourth aspect of the invention.

In a further aspect of the invention there is provided the use of reduced graphene oxide as a binder in a composition for an electrode.

In one embodiment, the composition is provided on a backing plate. In one embodiment, the composition is substantially free of an organic polymer binder. In a further embodiment, the composition is a composition as described above.

These and other aspects and embodiments of the invention are described in further detail below.

### SUMMARY OF THE FIGURES

FIG. 1 is the XRD spectra for graphene oxide produced by the Hummers' method and the modified Hummers' methods used in the present case. The spectra show the change in intensity (a.u.) with change in 2 theta (°).

FIG. 2 shows the XRD patterns recorded for vein graphite, graphite oxide and graphene oxide. The spectra show the change in intensity (a.u.) with change in 2 theta (°).

FIG. 3 is the UV/vis spectrum for graphene oxide. The spectrum shows the change in absorbance (a.u.) with change in wavelength (nm).

FIG. 4 is a pair of FTIR-ATR spectra for graphene oxide (top) and vein graphite (bottom). The spectrum shows the change in transmittance (%) with change in wavenumber (cm⁻¹).

FIG. 5 is a pair of SEM images for (a) the cross section of graphene oxide and (b) the surface of graphene oxide. The scale bars in FIGS. 5 (a) and (b) are 5 μm and 200 nm respectively.

FIG. 6 is a TGA plot for a graphene oxide for use in the invention, showing the change in weight (relative change, with respect to initial weight) with change in temperature (° C.) in an argon atmosphere.

FIG. 7 shows the FTIR spectra for a composite comprising reduced graphene oxide and activated carbon (RGO/AC); reduced graphene oxide (RGO); and activated carbon (AC). The spectra show the change in transmission (%) with change in wavenumber (cm⁻¹).

FIG. 8 is a series of SEM images of a carbon composite according to an embodiment of the invention, where the scale bars are 2.0 μm (top left), 10.0 μm (top right), 1.0 μm (bottom left) and 300 nm (bottom right).

FIG. 9 is a series of XRD patterns recorded for reduced graphene oxide (top), a composite comprising reduced graphene oxide and activated carbon (middle), and activated carbon (bottom). The spectra show the change in intensity (a.u.) with change in 2 theta (°).

FIG. 10 shows the Raman spectra for a composite comprising reduced graphene oxide and activated carbon (top); graphene oxide (second from top); reduced graphene oxide (third from top); and activated carbon (bottom). The spectra show the change in intensity (a.u.) with change in Raman shift (cm⁻¹).

FIG. 11 shows the change in specific capacitance (F/g) with change in potential (V) at different sweep rates (mV/s) for a supercapacitor according to an embodiment of the invention (supercapacitor A) and the comparative supercapacitors B, C and D.

FIG. 12 shows the change in relative specific capacitance (%) with change in potential (V) at different sweep rates (mV/s) for a supercapacitor according to an embodiment of the invention (supercapacitor A) and the comparative supercapacitors B, C and D. The relative specific capacitance is with respect to the specific capacitance of the device at 50 mV/s.

FIG. 13 shows (top) the change in potential (V) with the change in time (s) for a supercapacitor according to an embodiment of the invention (supercapacitor A), and the comparative supercapacitors B and C; and (bottom) the change relative specific capacitance (%) with change in current density (A/g) for a supercapacitor according to an embodiment of the invention (supercapacitor A), and the comparative supercapacitors B and C. The relative specific capacitance is with respect to the specific capacitance of the device at 2 A/g.

FIG. 14 is a series of Nyquist plots showing the change in Z″ (ohms) with change in Z′ (ohms) for a supercapacitor according to an embodiment of the invention (supercapacitor A) and the comparative supercapacitors B, C and D.

FIG. 15 is an expanded version of the Nyquist plots of FIG. 14 showing the change in Z″ (ohms) with change in Z′ (ohms) for a supercapacitor according to an embodiment of the invention (supercapacitor A) and the comparative supercapacitors B and C.

FIG. 16 is an expanded version of a Nyquist plot of FIG. 14 showing the change in Z″ (ohms) with change in Z′ (ohms) for the comparative supercapacitor D.

FIG. 17 is a Nyquist plot showing the change in Z″ (ohms) with change in Z′ (ohms) for an electrode comprising reduced graphene oxide obtained by heating at 200° C., 300° C. or 400° C.

### DETAILED DESCRIPTION OF THE INVENTION

The inventors have previously discussed the performance of reduced graphene oxide and activated carbon composites for high-power supercapacitors (Galhena et al. at Graphene 2014—abstract and poster).

However, the inventors have not previously described the methods required for the preparation of such composites. The composites described herein may be obtained only by controlled methods of preparation. These methods are not described or obvious from the earlier work of the present inventors.

For example, the inventors' earlier poster presentation does not describe the ratio of graphene oxide and activated carbon for use in the preparation of the composite.

Furthermore, no detailed synthesis information is provided. As explained in detail below, the weight ratio of components is an important factor in determining the performance of the composite material, and the temperature of the thermal reduction step is an important factor in determining the structure of the composite.

Moreover, the poster does not explain that reduced graphene oxide is capable of acting as a binder to hold the composite to a backing plate, or to hold together the particles of activated carbon.

The abstract disclosure also does not explain that the benefits of the invention are obtained when the graphene oxide is reduced in the presence of the activated carbon, such as when the mixture is reduced on a backing plate. This and other information is required in order to obtain the composites of the invention.

As described in detail below, the inventors have found that it is important to control the thermal reduction of graphene oxide in the preparation of a carbon composite. Galhena et al. do not describe the thermal reduction conditions that are required to prepare a useful composite. In particular, Galhena et al. do not describe to the skilled person how he might prepare a composite that is suitable for adhering to a backing plate, such as a current collector.

The inventors have established that reduced graphene oxide, obtainable from graphene oxide, may be used as a binder to hold together the active material of a capacitor electrode, and also to hold the composite of the reduced graphene oxide and the active material to a backing plate, such as a current collector.

As described herein, useful composites are obtained when graphene oxide is reduced in the presence of an active material, such as activated carbon, at relatively mild temperatures. Preferably, the reduction is performed whilst the mixture of graphene oxide and the active material is provided on a backing plate.

A composite that is prepared according to the methods of the invention exhibits an improved electrochemical performance as compared to the individual electrochemical performance of reduced graphene oxide or the active material, such as activated carbon. This improvement can be attributed to the synergistic effect of the active material and reduced graphene oxide.

The incorporation of reduced graphene oxide into a composite material provides a number of advantages. First, the reduced graphene oxide is capable of acting as a binder, and it may be used as an alternative to traditional binder materials. Second, the reduced graphene oxide is a conductive additive within the composite. Conductive additives are commonly added to electrodes composites, however in the present case the reduced graphene oxide additionally functions as a binder. In this way the reduced graphene oxide may be used to replace two separate additive materials in a composite. Third, the reduced graphene oxide is also capable of functioning as an active material, and is capable of storing charge.

The use of reduced graphene oxide may therefore simplify the composite material, whilst also providing a positive contribution to the total capacitance of the composite, thereby improving the performance of the composite within a supercapacitor.

The use of reduced graphene oxide also provides a composite with high tensile strength and, as noted above, the reduced graphene oxide also provides excellent adhesion. A supercapacitor using a composite with reduced graphene oxide has an improved cycling lifetime compared with composites using an active material together with a conventional binder, such as a conventional nonconductive polymer binder.

Conventional binders, which are described further below, generally provide no contribution to the total capacitance of the composite within the electrode of a capacitor. The composite of the present invention is therefore substantially free of conventional binders. The composites of the invention therefore use only reduced graphene oxide as the binder for the active material.

Reduced graphene oxide not only provides vacancies to accommodate ions, but also forms a network structure to conductively bridge the spaces between the active material, for example particles of active material such as particles of activated carbon. This facilitates rapid transport of the electrolyte ions within the electrode materials, leading to a high-rate performance of the electrode, which is accordingly suitable for use within a supercapacitor.

This is observed experimentally from the results of the cyclic voltammetry studies on the composite.

The near-rectangular cyclic voltammetry curves at ultrafast sweep rates, such as 1,000 and 1,500 mV/s show that very efficient charge transfer occurs within the composite.

It is believed that the surfaces of the reduced graphene oxide layers are involved in charge storage and this provides a contribution to the total capacitance. This effectively increases the proportion of electrochemically active material within the composite and accordingly, the capacity of the supercapacitor is increased.

Active Material

The active material for use in the composite is a material for use in an electrode, such as an electrode for a supercapacitor. In one embodiment, the active material is electrically conductive. The active material is capable of storing electrical charge.

In one embodiment, the active material is a carbon material, such as activated carbon. This is the standard material for use in supercapacitors owing to its low cost, large specific surface area and good chemical stability. However, other materials may be used in place of activated carbon in the composite and electrode of the invention. Exemplary materials are described further below.

However, the preferred active material is a carbon material, and most preferably activated carbon. Many of the graphene-based composites described in the art do not make use of a carbon active material. For example, US 2012/0321953 describes a composite material comprising a graphene derivative and vanadium oxide, CN 103515605 describes a composite material comprising graphene oxide and lithium vanadium phosphate, and CN 103275368 describes a composite material comprising silica and styrene-butadiene rubber.

In one embodiment, the active material is a particulate material. Thus, the reduced graphene oxide is used to bind particles of active material.

The active material may contain particles, such as carbon particles, having an average largest diameter of at most 20 μm. In one embodiment, the active material contains particles, such as carbon particles, having an average largest diameter of at most 10 μm, at most 5 μm, at most 1 μm, at most 0.1 μm, or at most 50 nm. In the worked examples of the present case activated carbon having an average largest diameter in the range 2 to 10 μm is used.

In one embodiment, the active material is porous.

The active material, such as activated carbon, may have a specific surface area of at least 100 m² g⁻¹, for example as determined by standard BET measurements with nitrogen adsorption at 77 K at varying pressures. In one embodiment, the specific surface area is at least 200, at least 500, at least 1,000, at least 1,500, or at least 2,000 m² g⁻¹. In the worked examples of the present case activated carbon having a specific surface area in the range 1,500 to 1,800 m² g⁻¹ is used.

The active material, such as activated carbon, may have a high total pore volume. The total pore volume may be at least 0.2, at least 0.4, at least 0.5, at least 0.6, at least 0.8 or at least 1.0 cm³ g⁻¹. The total pore volume may be determined using standard techniques, for example as estimated from the amount of nitrogen absorbed at a relative pressure of 0.98.

The active material, such as activated carbon, may have a high total volume of micropores. The total micropore volume may be determined using standard techniques, for example from nitrogen adsorption isotherms using the Dubinin-Radushkevich determination. The total micropore volume may be at least 0.1, at least 0.2, at least 0.3, at least 0.4, at least 0.5, at least 0.8 cm³ g⁻¹.

In one embodiment, the active material is a carbon active material.

The carbon active material may include activated carbon, carbon nano tubes, carbon nano horns, carbon nano onions, carbon fibre, carbon nano spheres, carbide-derived carbon, graphene, carbon black, and acetylene black.

In one embodiment, the active material is activated carbon. Activated carbon refers to carbon having high porosity and consequently a high surface area, such as the specific surface area, pore volume and total micropore volume values given above. Activated carbon is readily available from commercial sources.

In one embodiment, the activated carbon is a carbon that has not been chemically treated to modify the surface of the carbon particles. For example, the activated carbon is not KOH activated carbon.

In one embodiment, the activated carbon has an ash content of at most 2 wt %, at most 1 wt % or at most 0.5 wt %.

In one embodiment, the active material is a metal oxide, for example a metal oxide selected from the group consisting of TiO₂, ZnO, SnO₂, Co₃O₄, Fe₂O₃, MnO₂, Mn₃O₄, MnO, Fe₃O₄, NiO, MoO₂, MoO₃, CuO, Cu₂O, CeO₂, RuO₂, and NiO.

In one embodiment, the active material is a metal nanoparticle.

In one embodiment, the active material is a conductive polymer such as a conductive polymer selected from polyaniline, polypyrrole, and polythiophene.

In one embodiment, the active material has nanostructures such as quantum dots, nanofilms, nanoshells, nanofibers, nanorings, nanorods, nanowires, nanotubes, and the like.

Graphene Oxide and Reduced Graphene Oxide

The carbon composite described herein is prepared by thermally reducing graphene oxide in the presence of the active material, such as a carbon active material, such as activated carbon. The preparation of graphene oxide is well known in the art, and methods for the preparation of reduced graphene oxide from graphene oxide are also well known.

Reduced graphene oxide refers to the product that is obtained or obtainable from graphene oxide.

Graphene oxide is used as the raw material for the preparation of reduced graphene oxide. The reduced graphene oxide serves as a binder and a conductive additive within the carbon composite.

Graphene oxide for use in the present case may be obtained from graphite using the well-known Hummers' method, or the described variations of this method, or other known methods for the oxidation of a graphite material. Thus graphite is oxidised to yield layered graphite oxide. The layered graphite oxide is then exfoliated to provide graphene oxide.

The graphene layers are involved in charge storage and contribute to the total capacitance of the device.

The graphite oxide obtained from the Hummers' method is graphite which is oxidized in places and has oxide functional groups such as carbonyl, carboxyl, ether or hydroxyl groups bonded to its surface, and these functional groups may also be present at the edges of the graphene sheets. In graphite oxide the distance between graphene layers is increased due to the oxidation of the layers. Therefore, graphene oxide can be easily obtained by separation of the layers from each other by ultrasonic treatment or the like.

In the present case reduced graphene oxide, and the graphene oxide that is used to prepare it, is not particularly limited by the graphene oxide synthesis method, the type of graphite used for the oxidation, the oxidation level of graphene oxide layers, the degree of separation of the graphene oxide layers, or the flake size of graphene oxide.

Examples of graphite for use in the Hummers' method includes natural graphite, such as flake graphite, vein graphite, and synthetic graphite, such as expandable graphite, and highly oriented pyrolytic graphite.

The inventors have found that the capacitance properties of the composite are enhanced if the impurities in the graphene oxide are minimised. In particular, the inventors have found that presence of non-electrolyte ions, such as metal ions, within the composite increases the electrical resistance of the composite. It is therefore advantageous to reduce the amount of these ions present within the composite, either by taking steps to remove the ions, or by avoiding the use of reagents that might introduce the ions into the composite during preparation. As discussed in further detail below, the composites of the invention preferably also do not contain binders, which can be a further source of contaminants into the composite.

The amount of Na ion in the graphene oxide may be minimised by avoiding the use of sodium salts, such as NaNO₃, in the preparation. For example, phosphoric acid may be used as an alternative. In one embodiment, the graphene oxide is substantially free of Na ion.

In the original Hummers' method the amount of Mn ion present in the graphene oxide is reduced, for example by treating the graphene oxide with peroxide, such as hydrogen peroxide. In one embodiment, the graphene oxide is substantially free of Mn ion.

The amount of CI ion present in the graphene oxide may be minimised by avoiding the use of chlorine salts during the preparation. For example, a HCl washing step may be omitted from the preparation and work up. In one embodiment, the graphene oxide is substantially free of CI ion.

The presence (or absence) of contaminating species may be determined using standard analytical techniques. The presence of Mn, as a component of the oxidising agent MnO₄, may be determined from the XRD spectrum of the graphene oxide and the composite containing the graphene oxide. The presence of other species may also be determined from the XRD spectrum.

The Hummers' method comprises the step of treating graphite with a mixture of sulfuric acid and potassium permanganate. In an adaptation of the Hummers' method, the amount of sulfuric acid and potassium permanganate used in the present preparations may be increased, as may the reaction timings. The inventors have found that these conditions ensure that no unoxidised graphite remains after the reaction. The reaction and work-up conditions employed by the inventors ensures that no unreacted potassium permanganate remain after the reaction is complete.

Thus, in one embodiment, graphite may be treated with concentrated sulfuric acid, such as 95-98% sulphuric acid.

The weight to volume ratio (w/v) of graphite to sulfuric acid may be 1:10 or more, such as 1:25 or more, such as 1:50 or more, such as 1:100 or more. For example, in the reaction exemplified in the present case, 1 g of graphite is treated with 100 mL of concentrated sulfuric acid.

Graphite may be treated with a weight excess of potassium permanganate. The weight to weight ratio (w/w) of graphite to potassium permanganate may be 1:1.1 or more, such as 1:1.5 or more, such as 1:2 or more, such as 1:3 or more. For example, in the reaction exemplified in the present case, 1 g of graphite is treated with 3 g of potassium permanganate.

The graphite may be treated with a mixture of sulfuric acid and potassium permanganate for 1 hour or more, 2 hours or more, or 3 hours or more. For example, in the reaction exemplified in the present case, the graphite is treated with a mixture of sulfuric acid and potassium permanganate for 3 hours.

Many of the impurities described above are known to undergo redox reactions within the voltage range typically with a supercapacitor (+2.7 V to −2.7 V in a typical charge discharge cycle of a supercapacitor with an organic electrolyte). Such redox activity initiates undesirable side reactions, and consequently reduces the performance of the device. See, for example, Batalla Garcia et al. who discuss the presence of impurities within carbon electrodes for use in supercapacitors.

The inventors prepared graphene oxide using the reported Hummers' method and compared the product with the product obtained by the adapted method described above. In the XRD spectrum of the graphene oxide obtained by the reported Hummers' method unoxidised graphite was observed, whilst no such graphite was observable in the XRD spectrum of the graphene oxide obtained by the modified method.

As described in further detail below, the inventors have found that the reaction conditions employed in the thermal reduction of graphene oxide are important for determining the properties of the carbon composite.

Composite

The present inventors have found that a composite of an active agent, such as a carbon active material, such as activated carbon, and reduced graphene oxide, prepared as described herein, is suitable for use within an electrode, such as an electrode for a supercapacitor.

Typically, within the art, electrodes for supercapacitors contain activated carbon together with a binder material to hold the carbon particles of the activated carbon together, and to allow the mixture to adhere to a current collector provided as a backing plate. The binder materials commonly used are nonconductive polymers, and accordingly these materials do not contribute to the overall conductivity and capacitance of the electrode.

In particular, the inventors have found that reduced graphene oxide may be used to effectively bind a composite containing activated carbon, thereby avoiding the need to use other binding materials. The presence of reduced graphene oxide improves the power density of the composite as well as improving the conductivity, capacitance and electrochemical cycle life of the composite. Within the composite, reduced graphene oxide acts as a binder and a conductive additive increasing the specific capacitance and the power density of the composite. The present invention therefore avoids the need to use an additional binder material in the composite to provide adherence to a backing plate.

In the present case the ratio of activate agent to graphene oxide is selected to provide optimal structural and electrical performance of the composite.

The inventors have found that high levels of graphene oxide (and therefore high levels of reduced graphene oxide) reduce the specific capacitance of the composite. This reduction is believed to be caused by the graphene oxide blocking the pores of the active agent, such as activated carbon. The inventors have also found that at low levels of graphene oxide (and therefore low levels of reduced graphene oxide) the binding of particles within the composite is poor and, additionally, the binding of the composite to the backing plate is poor. For this reason, the amount of graphene oxide, with respect to the amount of active agent, is used in the amounts given below.

Thus, the composite should contain sufficient reduced graphene oxide to provide sufficient binding and yet should not contain excessive graphene oxide that would reduce porosity.

Thus, in the methods of the invention, the amount of graphene oxide present in the mixture for preparing the composite may be controlled to ensure an appropriate level of reduced graphene oxide in the composite product.

From the SEM images of composite materials the inventors have found that where an excess of graphene oxide is used in the methods of preparation, the pores of the activated carbon in the product are seen to be blocked.

The composite is prepared from a mixture of graphene oxide and an active material, such as a carbon active material, such as activated carbon. The weight ratio of graphene oxide to active material is within set limits, as the properties of the resulting composite are dependent upon the relative amounts of material present. Thus, for example, the composite is obtained or obtainable from a mixture of graphene oxide and an active material where the weight ratio of graphene oxide to active material in the mixture is in the range 1:1 to 1:50. The weight ratios are discussed in further detail below with respect to methods for the preparation of a carbon composite.

During the preparation of the composite, a mixture of graphene oxide and an active material, such as activated carbon, is subjected to a heat treatment, to a temperature in the range 200 to 400° C. TGA of graphene oxide shows that there is a decrease in mass of the graphene oxide which is associated with the loss of oxide functionality during the heat reduction. It follows that the weight ratio of reduced graphene oxide to active material in the product composite is different to that of the weight ratio of graphene oxide to activated carbon in the starting mixture for preparation of the composite.

Considering the TGA analysis of graphene oxide during heat treatment, it is seen that there is a reduction in mass of around 35 wt % when a heat treatment of 300° C. is used. Thus, the weight amount of reduced graphene oxide in the composite may be 65 wt % of the amount of graphene oxide in the mixture for preparing the composite.

The composite may include other components, for example to enhance the physical and chemical, including electrochemical, properties of the electrode. However, in the present case it is possible to use reduced graphene oxide as an alternative to conventional binders and conductive additives.

In one embodiment, the carbon composite is substantially free of a conventional binder, such as an organic binder, such as a nonconductive polymer binder. In the present composite, the reduced graphene oxide binds the activated carbon particles. Thus the present composite avoids the use of nonconductive polymers, which do not contribute to the overall conductivity and capacitance of the composite.

In one embodiment, the amount of a binder, such as a polymer binder, present in the composite is less than 5 wt %, such as 2 wt % or less, such as 1 wt % or less, such as 0.5 wt % or less.

Conventional binders described for use in electrode materials include nonconductive polymer binders such as polyvinylidene fluoride (PVDF), polytetrafluoroethylene (PTFE), polyimide, polyvinyl chloride (PVC), ethylene propylenediene polymer, styrene-butadiene rubber (SBR), acrylonitrile-butadiene rubber, fluorine rubber, polyvinyl acetate, polymethyl methacrylate, polyethylene, nitrocellulose, carboxy methyl cellulose (CMC) amongst others. The composite of the invention is substantially free of such binders.

Typically, a polymer binder, such as polyvinylidene fluoride (PVdF) is used as the binder in preparing supercapacitor electrodes. However, these nonconductive polymer binders reduce the amount of the active material present in the electrode. They also increase the electrical resistance of the electrode due to electrical insulation. Thus, the performance of the supercapacitor may be reduced. For this reason, the composite of the invention is substantially free of an organic binder.

Polymer binders are liable to swell when contacted with electrolyte. This can have the effect of separating the active material (such as particles of active material) within the composite, significantly increasing the ohmic resistance (such as inter-particle ohmic resistance).

In contrast, reduced graphene oxide does not swell in the electrolyte. The reason for this is that graphenes are layered materials, and graphene oxide layers are exfoliated prior to their incorporation into the composite. If further exfoliation were to take place within the composite, it would actually improve the capacitance and cycle life of the supercapacitor Impurities, such as non-electrolyte salts, iron, and manganese to name a few, within a binder can also be highly deleterious to supercapacitor performance. Therefore it is necessary to use a high purity binder material in order to minimize unwanted side reactions in the electrochemical process. Additionally other additives, such as carbon black and acetylene black, are conventionally added to composites to improve electrical conductivity. Such are typically not present in the composite of the invention, as the reduced graphene oxide anyway provides a contribution to the electrical conductivity of the composite.

Furthermore, where conductive additives such as carbon black and acetylene black are used, they are normally present as particles within a composite, and these particles make point contacts with the active material. Reduced graphene oxide has layers that make surface contacts with the active material. Here, there is low contact resistance and the electrical conductivity with the composite is improved.

In one embodiment, the composite is substantially free of a conductive additive. Thus, the amount of conductive additive present in the composite is less than 10 wt %, such as less than 5 wt %, such as 2 wt % or less, such as 1 wt % or less, such as 0.5 wt % or less.

The composite has very useful electrochemical properties, and the electrochemical performance of the composite is enhanced in comparison with activated carbon and reduced graphene oxide. For example, the composite has a higher capacitance than activated carbon and reduced graphene oxide.

As noted above, reduced graphene oxide has binder and conductive additive properties, and there is little need to include additional binders and conductive additives in the composite of the invention.

The capacitance may be determined using cyclic voltammetry (CV) techniques.

In one embodiment, the composite has a specific capacitance of at least 20, at least 40, at least 50, at least 60, at least 80, at least 100, or at least 110 F/g at a scan rate of 50 mV/s.

In one embodiment, the composite has a specific capacitance of at least 20, at least 30, at least 40 F/g at a scan rate of 1,500 mV/s.

In the worked examples of the present case, the capacitance of an example composite was determined by CV as 77 F/g at 50 mV/s and 60 F/g at 1,500 mV/s.

The composite may be analysed by standard spectroscopic techniques, such as IR and Raman spectroscopy, X-ray diffraction (XRD) and SEM, amongst others.

Carbon Composite Preparation

The carbon composite is prepared by thermal reduction of a mixture of graphene oxide in the presence of the active material, such as activated carbon.

The graphene oxide and active material are typically provided as a mixture in a solvent. The solvent may be an organic solvent. The solvent may be a polar solvent, for example possessing O or N atoms. The solvent may be an aprotic solvent, which lacks an acidic hydrogen, such as present in —OH and —NH—.

In one embodiment, the solvent is propylene carbonate (PC).

The use of propylene carbonate is particularly preferred as this solvent may also be used as a component of an electrolyte in an electrochemical cell having an electrode as described herein.

In one embodiment, the weight ratio of graphene oxide to active material in the mixture is 1:1 or more, such as 1:2 or more, such as 1:5 or more.

In one embodiment, the weight ratio of graphene oxide to active material in the mixture is 1:50 or less, such as 1:25 or less, such as 1:20 or less, such as 1:15 or less.

In one embodiment, the weight ratio of graphene oxide to active material in the mixture is in the range selected from the upper and lower limits given above. Thus, the weight ratio of graphene oxide to active material in the mixture is in the range 1:1 to 1:50, such as 1:2 to 1:25, such as 1:5 to 1:15.

In one embodiment, the weight ratio of graphene oxide to active material is about 1:10.

As noted above in relation to the ratio of reduced graphene oxide to active material, the amount of reduced graphene oxide in the composite is related to the porosity of the composite and the binding of the composite.

The inventors have found that temperature control in the reduction step is an important factor in determining the properties of the resulting composite.

The temperature should be sufficient to permit reduction of the graphene oxide. The reduction of graphene oxide is associated with an increase in electrical conductivity. Thus, in one embodiment, the thermal reduction is performed at a temperature of at least 200, at least 250 or at least 275° C.

It has been established that excessive temperatures in the reduction reaction are associated with a reduction in the beneficial properties of the composite. At high temperatures the rapid undesirable and uncontrolled thermal expansion of the composite is observed and, where the composite is provided on a backing plate, this is also associated with the detachment of the composite from the plate. Thus, high reduction temperatures are linked to a loss in the adhesive properties of the composite.

Thus, the reduction temperature is selected to minimise or avoid thermal expansion of the composite. Thus, in one embodiment, the thermal reduction is performed at a temperature of at most 325, at most 350, at most 400, at most 450, at most 500, at most 600, or at most 650° C.

The inventors have found that the most preferred temperatures for the heating step are at most 450° C., such as at most 400° C., such as at most 350° C., such as at most 325° C. Here, thermal expansion is at a minimum level, and the composite material has the optimal adherence properties, for example to adhere the composite to a backing plate.

It is noted that the heating steps described in the art for the thermal reduction of graphene oxide-containing composites are typically preformed at temperatures in excess of 500° C.

For example, CN 103794379 and CN 104064755 describe heating graphene-based composites at a temperature in the range 500-700° C. At these higher temperatures there is an increased risk of thermal expansion, and also a reduction in the adherence properties of the composite. The structures of the resulting composites will therefore differ to those of the present case.

Where the reduction is performed under reduced pressure, the reaction temperatures are generally lower, such as with the range 250 to 350° C. mentioned above. Where the reduction is conducted at ambient pressure, it may be performed at temperatures that are above the upper limit of this range.

In one embodiment, the thermal reduction is performed at a temperature in a range selected from the lower and upper temperatures given above. Thus, the thermal reduction is performed at a temperature in the range 250 to 350° C., such as 275 to 325° C.

In one embodiment, the reduction temperature is about 300° C.

The duration of the thermal reduction step also influences the properties of the final composite. It has been found that extended thermal treatments also increase the probability of thermal expansion in the composite. Thus, extended thermal treatments are to be avoided, where possible. In one embodiment, the thermal reduction is performed for at most 1 hour, at most 2 hours, or at most 4 hours.

Of course, the thermal reduction is performed for a time sufficient to allow for at least partial reduction of the graphene oxide. Thus in one embodiment, the thermal reduction is performed for at least 15 min., at least 30 min., or at least 45 min.

The thermal reduction is typically performed in an atmosphere substantially free of oxygen. Thus, the thermal reduction may be performed under a nitrogen and/or argon atmosphere. Excluding oxygen prevents re-oxidation of the reduced graphene oxide.

The thermal reduction reaction is also typically performed at reduced pressure. Thus, the pressure during the thermal reduction reaction is less than ambient pressure, such as less than 101.3 kPa, for example 50 kPa or less, such as 10 kPa or less.

However, extremely low pressures are to be avoided as such pressures are associated with the undesirable expansion of the composite, with the associated loss of adherence. In one embodiment, the thermal reduction is performed at a pressure and the pressure is 0.1 kPa or more, 0.5 kPa or more, or 1.0 kPa or more.

Methods for performing thermal reduction reactions at reduced pressures in the absence of oxygen are well known in the art.

During the thermal reduction, the mixture of activated carbon and graphene oxide is heated to a temperature such as described above. After the reduction is deemed complete the product composite is permitted to cool, such as to room temperature (such as a temperature in the range 15 to 25° C.). In one embodiment, the carbon is cooled at a rate of at most 1° C. min⁻¹, at most 2° C. min⁻¹, or at most 5° C. min⁻¹.

Where the thermal reduction is performed at reduced pressure and/or under an oxygen-free atmosphere, the composite may be maintained under these conditions during the cooling process. The inventors have found that these conditions minimise or prevent oxidation of the composite, and where the composite is present on a backing plate, the oxidation of the backing plate is also minimised or prevented.

In practice, the composite is retained in the reaction vessel after the heat treatment, and the reaction vessel is permitted to cool to ambient (room) temperature.

The worked examples describe the use of an aluminium foil backing plate for the composite. Extensive discolouration of the aluminium backing plate is observed when the composite is not cooled under the conditions described above.

Electrode

The composite of the present case is suitable for incorporation into an electrode, such as an electrode for use in a capacitor.

Thus, the present case provides an electrode comprising the carbon composite. A composite of the invention may be used directly as an electrode. However, typically the electrode comprises the carbon composite on a backing plate. The backing plate may provide structural support for the composite. The backing plate may be an electrically conductive plate.

The backing plate may be a current collector, and permits the transfer of electrical current to and from the composite within an electrical circuit. In this embodiment, the backing plate is electrically conductive.

The shape, size and structure of the backing plate are not particularly limited, and the choice of backing plate will depend upon the intended use of the electrode with an electrical circuit.

The current collector is a highly conductive material which does not react with the electrolyte. Example materials for the backing plate, such as the current collector, include metallic current collectors which are or contain aluminium, stainless steel, gold, platinum, zinc, iron, nickel, or copper. The current collector may be or contain aluminium. Alternatively, the current collector can be made from a conductive polymer.

The current collector can be a foil, a sheet or plate, a mesh, or similar. The current collector is typically greater than 3 microns thick.

The current collector may be coated, etched or otherwise treated or processed to improve its conductivity.

Capacitor

The electrode of the invention may be provided as a component of a capacitor. Accordingly, the present invention provides a capacitor comprising an electrode of the invention, such comprising two electrodes of the invention.

The capacitor may have a first electrode, which is an electrode of the invention, which first electrode is spaced apart from a second electrode, which is optionally an electrode of the invention, wherein the interelectrode space is occupied by a dielectric, such as an electrolyte.

The interelectrode space may be provided with an ion-permeable insulator (or separator) and a liquid electrolyte. The ion-permeable insulator permits the exchange of ions between the sides of the interelectrode space, whilst preventing transfer of electrons (electrically insulating). The insulator is porous.

The insulator may have a thickness of from 5 to 300 μm. The insulator, where present, may occupy substantially all of the interelectrode space.

An electrolyte may comprise a solvent and carrier ions, and such as are well known for use in supercapacitors. This may be referred to as an electrolyte solution.

Example additives for providing carrier ions within the electrolyte are tetraalkylammonium salts such as TEATFB (tetraethylammonium tetrafluoroborate), MTEATFB (methyltriethylammonium tetrafluoroborate), and EMITFB (1-ethyl-3-methylimidazolium tetrafluoroborate; triethylammonium based salts; lithium salts (for eg. in batteries); and other alkali metal salts; H₂SO₄, and KOH amongst others.

The solvent may be selected based on the nature of the carrier ion, the final application of the capacitor, required performance and so on.

In some embodiments the solvent may be an aprotic organic solvent such as ethylene carbonate (EC), propylene carbonate (PC), dimethyl carbonate (DMC), diethyl carbonate (DEC), γ-butyrolactone, acetonitrile, dimethoxyethane, tetrahydrofuran, and the like

In some embodiments the solvent may be water.

In some embodiments the solvent may be a gelled high-molecular material such as a silicone gel, an acrylic gel, an acrylonitrile gel, polyethylene oxide, polypropylene oxide, a fluorine based polymer, and the like.

As an alternative to an electrolyte solution, an ionic liquid (such as a molten salt) or a solid electrolyte may be provided within the interelectrode space. In both cases there is no requirement for a solvent.

Examples for ionic liquids include N-butyl-N-methylpyrrolidinium bis(trifluoromethanesulfonyl)imide (PYR₁₄TFSI) and 1-ethyl-3-methylimidazolium bis(trifluoromethylsulfonyl)amide (EMIM-NTf₂)) amongst others.

If a solid electrolyte is used it is not necessary to provide an ion-permeable insulator between the two electrodes. Examples of solid electrolytes include sulfide-based inorganic materials, oxide-based inorganic materials, and macromolecular materials such as a polyethylene oxide (PEO)-based macromolecular materials.

The ion-permeable insulator may be selected from cellulose, glass fibres, polyethylene and polypropylene. The ion-permeable insulator may be in the form of a paper, mesh or some other screen.

In one embodiment, the capacitor comprises two electrodes of the invention, where the electrodes are disposed in opposition to one another.

In one embodiment, the capacitor is a supercapacitor. Here, an electrolyte is provided in the capacitor between the two electrodes of the cell. An ion permeable insulator membrane is typically provided between the electrodes allowing the exchange of ions and preventing the transfer of electrons between the electrodes.

As explained above, the combination of reduced graphene oxide with an active material such as activated carbon provides a composite of sufficient priority to allow rapid transport of electrolyte ions throughout the composite. Accordingly, the composites of the invention have a high-rate performance when used as electrodes in supercapacitors. Experimentally, the high-rate performance is apparent from the behaviour of the composite as a component in an electrode analysed by cyclic voltammetry and galvanostatic charge discharge measurements. The composite has near-square CV curves even at rapid sweep rates, for example at 1,500 mV/s, which is representative of efficient charge transfer to and from the composite.

The capacitor, such as the supercapacitor, may be a coin type, button type, pouch type, cylindrical type, prismatic type or any other type.

The capacitor may further comprise a source of electrical current in electrical connection with the electrode.

In a further embodiment there is provided the use of an electrode in a capacitor, such as the use of an electrode in a supercapacitor.

In yet another aspect of the invention there is provided a method of charging a capacitor, the method comprising the steps of (i) providing a capacitor having a first electrode, which is an electrode of the invention, which first electrode is spaced apart from a second electrode, which is optionally an electrode of the invention, wherein the interelectrode space is occupied by a dielectric; and (ii) generating an electrostatic field between the first and second electrodes.

In a further aspect of the invention there is provided a method of discharging a capacitor, the method comprising the steps of (i) providing a capacitor having a first electrode, which is an electrode of the invention, which first electrode is spaced apart from a second electrode, which is optionally an electrode of the invention, wherein the interelectrode space is occupied by a dielectric and an electrostatic field is present between the first and second electrodes; and (ii) dissipating the electrostatic field between the first and second electrodes.

In the aspects above, the dielectric may be an electrolyte, for example as present in a supercapacitor. The capacitor may be a supercapacitor.

Use of Reduced Graphene Oxide

The present inventors have established that reduced graphene oxide may be used as both a binder and a conductive agent in a carbon composite, such as a carbon composite for an electrode, which may be an electrode for a supercapacitor.

Thus, in a further aspect of the invention there is provided the use of reduced graphene oxide as a binder in a composite for an electrode.

The composite may be a carbon composition as described herein, such as is obtainable by heating a mixture of graphene oxide and an active material at a temperature in the range 200 to 650° C. For example, the composite may be provided on a backing plate. The composite may be substantially free of an organic polymer binder.

Given that reduced graphene oxide acts as a conductive agent, the composite may be substantially free of further conductive agents. Thus, carbon black may be substantially absent from the composite.

Other Preferences

Each and every compatible combination of the embodiments described above is explicitly disclosed herein, as if each and every combination was individually and explicitly recited.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

Certain aspects and embodiments of the invention will now be illustrated by way of example and with reference to the figures described above.

Experimental and Results

General Experimental—Analyses

The microstructure of materials was observed by field-emission scanning electron microscopy (SEM, Zeiss SigmaVP and Hitachi S-5500).

Raman spectroscopy measurements were performed by using a Ramascope-1000 system (Renishaw) with laser wavelength 633 nm.

Thermogravimetric analysis (TGA) for a sample was carried out in nitrogen atmosphere from ambient to 1000° C. at a heating rate of 10° C./min, by a Q50 TGA (TA Instruments) TG-DTA thermal analyser.

Attenuated total reflectance Fourier-transform infra-red (ATR-FT-IR) spectra of film were recorded on a Perkin-Elmer Frontier ATR-FT-IR spectrometer with a UATR Sampler with a germanium crystal (ATR mode with ZnSe crystal).

The crystallographic structure of a sample was characterized by X-ray diffraction (XRD) using a D8 instrument (Bruker) in which Cu Kα used as the radiation source (λ=1.5406 Å, with θ/2θ configuration).

UV-Vis absorbance spectra were obtained using a Shimadzu UV-3101 PC UV-Vis NIR scanning spectrophotometer.

General Experimental—Reagents

Activated carbon was obtained from a commercial supplier. In the present work coconut shell activated carbon (steam activated carbon) was used (YP-50F from Kuraray Carbons). The YP-50F product is reported as having a surface area in the range 1,500 to 1,800 m²/g, an average largest dimension of 2 to 10 μm, and an ash content of 1 wt % or less.

The preparation of graphene oxide is described below.

In the preparation of the carbon composite, an Al foil is used. The Al foil was obtained from a commercial supplier as a conductive coated aluminium foil. The foil is described in further detail below.

Synthesis of Graphene Oxide

Graphite oxide was synthesized from natural vein graphite (purity >99%, Bogala graphite, Sri Lanka) by a variation of the original Hummers' method.

The oxidation of graphite to graphite oxide was accomplished by stirring powdered vein graphite (1 g) into concentrated sulfuric acid (100 mL, 95-98%). The ingredients were mixed in a flask that had been cooled to 0° C. in an ice-bath. Whilst maintaining vigorous agitation, potassium permanganate (3 g) was added to the suspension. The rate of addition was controlled carefully to prevent the temperature of the suspension from exceeding 10° C. The ice-bath was then removed and the mixture was left for about 3 h with stirring. As the reaction progressed, the mixture gradually thickened with a reduction in effervescence. The mixture then became pasty with evolution of only a small amount of gas. The paste was brownish grey in colour.

After 3 h, deionized water (100 mL) was slowly stirred into the paste, causing violent effervescence and an increase in temperature. The diluted suspension, now brown in colour, was left stirring for 15 min. The suspension was then further diluted to approximately with 1.5 L with deionized water, and treated with 30% hydrogen peroxide (typically 10 mL, and more if required) until the suspension turned bright yellow while stirring. The suspension was filtered resulting in a yellow-brown filter cake.

The resulting graphite oxide product was further washed with deionized water (by dispersing the graphite oxide in deionized water and centrifuging at 6,000 rpm for multiple times) until the pH of the rinse water was neutral (pH=7).

The purified graphite oxide was then dispersed in deionized water again. Exfoliation of graphite oxide to graphene oxide was achieved by ultrasonication of the dispersion for at least 15 min.

A graphene oxide dispersion prepared according to the above procedure was then poured into a Petri dish and dried in a drying oven maintained at a temperature of 50° C. until the produce reached a constant weight, to obtain films of graphene oxide attached to the Petri dish. These graphene oxide films consisted of graphene oxide layers which settled and re-stacked upon drying of the films (from their dispersed state in solution). Completely dried, GO films were then carefully peeled from its substrate and used for further characterization and supercapacitor electrode fabrication.

Ultrapure Milli-Q® deionized water was used in all experiments.

The Hummers' method was originally described by Hummers et al. The method described above is an adaption with a number of noteworthy changes.

Sodium nitrate (NaNO₃) is not used as a reagent in the synthesis. Contaminating metal ions within an electrode material are known to reduce the cycle life of the electrode in a supercapacitor, for example due to competing side reactions. The metal ion impurities can cause self discharge of the supercapacitor. The by-products of the side reactions are also known to block the pores of the carbon electrode, thereby cycle life of the electrode.

Further, a conductive contaminant in a supercapacitor electrode can cause the electrode to physically or chemically short-circuit. Thus, the materials used for the formation of an electrode should be substantially free of any conductive foreign substances, such as metallic foreign substances. For example, Batalla Garcia et al. note that the presence of metal ion impurities, in activated carbon for example, can later reduce the performance of a capacitor.

The amount of sulfuric acid and potassium permanganate used differs from the original Hummers method, as do the reaction times for the sulfuric acid and potassium permanganate treatments. Thus, the amounts used were greater than the originally reported method. These adaptation ensured that the graphite was completely oxidised, and unreacted potassium permanganate was not present after the reaction. Analysis of the XRD spectra (see below) confirmed that unreacted graphite and unreacted potassium permanganate were not present in the product, as the expected peaks for these materials were absent in the product XRD spectrum.

As with the original Hummers method, ion exchange resins were not, nor were the products washed with HCl, as is common in other variations of the Hummers method. It was found that washing the intermediate graphite oxide with deionized water was sufficient to yield a product suitable for use in a capacitor.

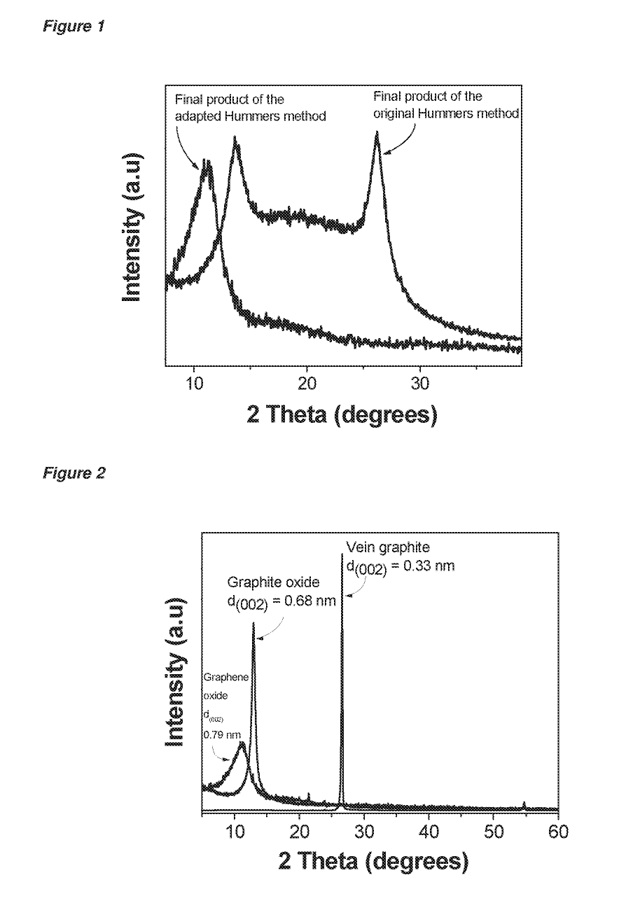

For comparison, graphene oxide was prepared by the reported Hummers' method and compared with the graphene oxide prepared using the method described above. The products were analysed by XRD, and the spectra are shown in FIG. 1.

With the original Hummers' method, graphite, which is not oxidized during the preparation, remains after the reaction and this is confirmed by the presence of the (002) peak of the vein graphite at 2θ=26.6°. However, with the adapted method, the absence of the (002) peak confirms that no vein graphite remains after the reaction.

XRD of Graphite and Graphene Oxide

The XRD spectra for vein graphite, graphite oxide and graphene oxide were collected and are shown in FIG. 2. The intensity of the graphite oxide and graphene oxide curves is multiplied by a factor of 300 and 1,000 respectively for clarity.

The representative (002) peak of the vein graphite is found at 2θ=26.6° indicating that the interlayer distance, d₀₀₂, is approximately 0.33 nm. For graphite oxide, the (002) peak shifts to 2θ=12.95°, corresponding to an interlayer distance of 0.68 nm. For graphene oxide the (002) peak further shifts to 2θ=11.2°, corresponding to an interlayer distance of 0.79 nm.

The increase in the interlayer distance between each graphene layer can be attributed to the oxidization induced expansion resulting in the presence of the oxygen containing functional groups in this case. Exfoliation assisted by ultrasonication increase the interlayer distance further. The XRD pattern of graphite oxide and graphene oxide shows no reflection at 2θ˜26° which indicates the absence of unoxidized graphite residues. Also, the (002) peak broadens, from graphite to graphite oxide to graphene oxide, indicating an increase in disorder when converting graphite to graphene oxide.

UV/Vis and IR Analyses

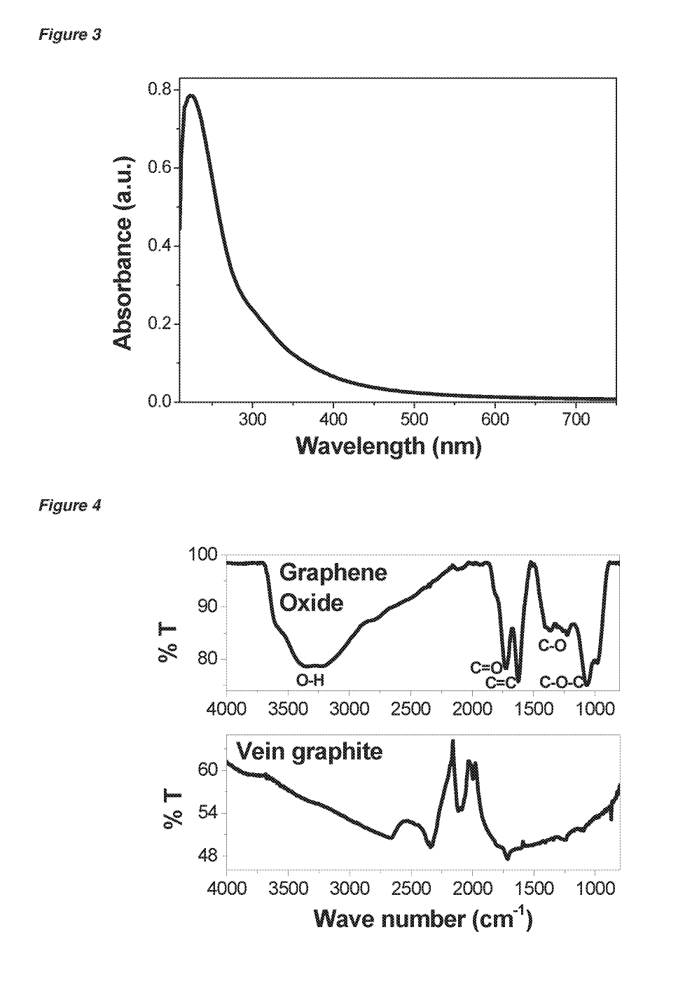

The UV/vis spectrum of the graphene oxide aqueous dispersion has a λₘₐₓ around 224 nm (see FIG. 3). The shoulder which is observed around 300 nm can be attributed to n→π* transitions of the carbonyl groups.

The oxidation of graphene plates and the presence of surface oxides in the graphene oxide is further confirmed by FTIR.

FTIR-ATR spectra were obtained for graphene oxide paper and graphite for comparison (see FIG. 4). The FTIR spectrum of graphene oxide samples was difficult to interpret due to the overlapping bands from numerous chemical bonds. The graphene oxide spectrum displays the broad O—H stretch in the 3,700-2,400 cm⁻¹ region. The band around 1,721 cm⁻¹ is due to C═O stretching vibration of a carbonyl group. Some researchers assign the band at 1,624 cm⁻¹ to the unoxidized sp² C═C bond, and others assign it to water bending modes. The bands at 1,226 cm⁻¹ and 1065 cm⁻¹ are attributed to C—O vibrations and C—O—C vibrations respectively. However, interpretation of the bands in the fingerprint region (from about 1500-500 cm⁻¹) differs in the literature, and such interpretations are not discussed here.

For a discussion of FTIR signals see, for example, Marcano et al., Shim et al., Acik, et al., Mermoux et al., Szabó et al., Szabó et al., Dimiev et al., and Gao et al.

SEM Analysis

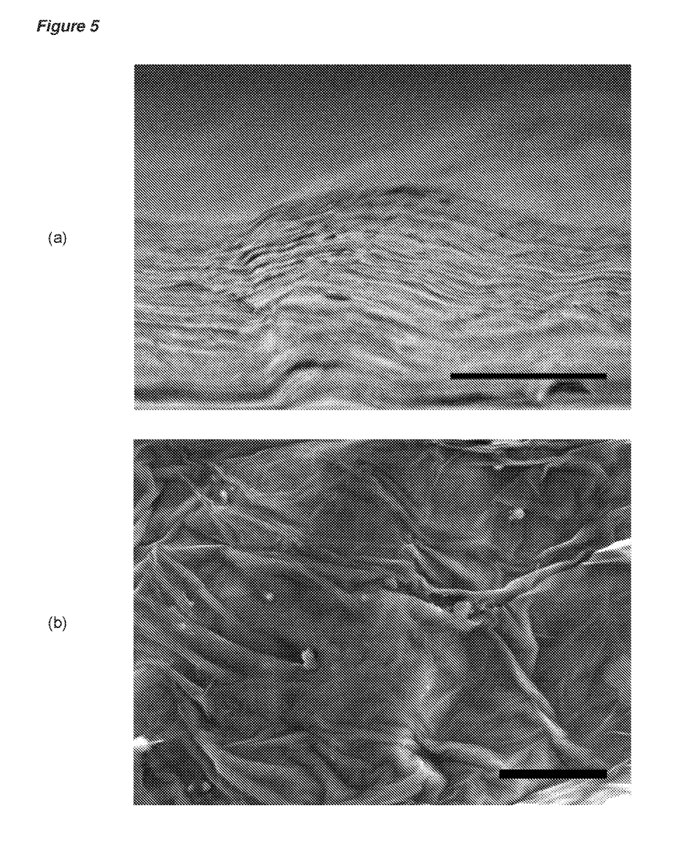

The morphology of the synthesized graphene oxide was examined by SEM in its dry state. SEM images were taken at both the surface (see FIG. 5 (b)) and the cross section (see FIG. 5 (a)).

The surface of the graphene oxide is fairly smooth at low magnification, however the high magnification SEM image (FIG. 5 (b)) shows thin, fluffy and wrinkled platelets transparent to electrons. SEM images of the cross sections confirms that within a completely dried graphene oxide, the sheets begin to align, resulting in the formation of a densely and homogeneously stacked graphene oxide film. Also, there are pocket-like void spaces between the closely packed graphene oxide sheets.

The scale bars are 5 μm and 200 nm in FIGS. 5 (a) and 5 (b) respectively.

TGA Analysis

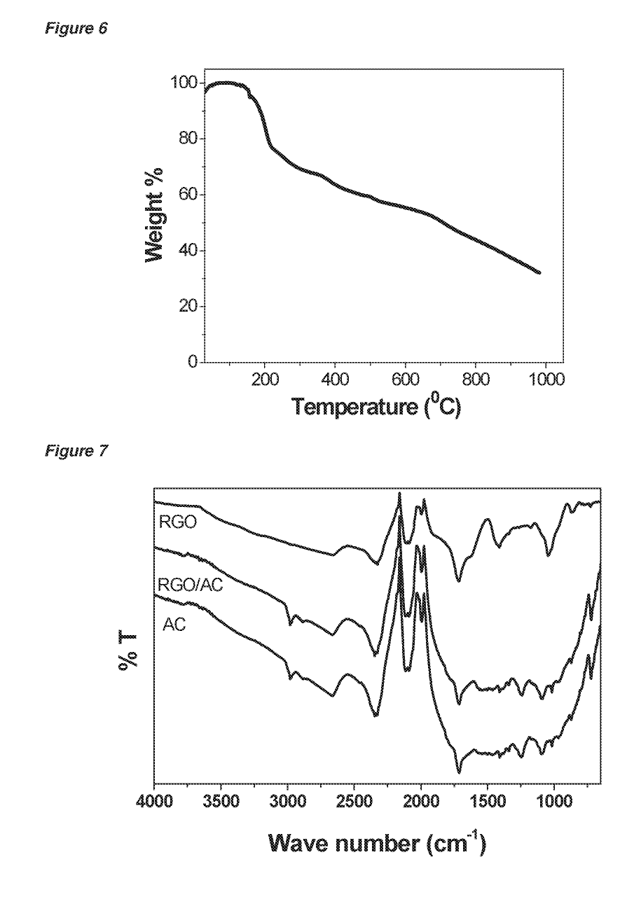

FIG. 6 is a TGA plot for the graphene oxide for use in the invention, showing the change in weight (relative change, with respect to initial weight) with change in temperature (° C.).

Thermogravimetric analysis (TGA) of the sample confirms the successful production of a graphene oxide paper. The major weight loss in the product was observed between 150 and 250° C., which corresponds to CO, CO₂, and steam release from the most labile functional groups. After that, a slower mass loss was observed and can be attributed to the removal of more stable oxygen functionalities. Carbon dioxide comes from the decomposition of carboxyl-type groups and carbon monoxide from carbonyl, hydroxyl and ether groups.

Preparation of Carbon Composite and Electrode

Graphene oxide as prepared by the method describe above and commercially available activated carbon were added to propylene carbonate and then mixed.

The ratio of graphene oxide to activated carbon was set to 1:10 by weight. The actual weight ratio of reduced graphene oxide to activated carbon in the electrode layer obtained after the electrode layer is applied on to the current collector and the reduction is performed is about 0.65:10 by weight. This is because the weight of the starting graphene oxide is reduced by about 35% during the reduction of the graphene oxide due to the removal of oxide groups (as observed in the TGA of graphene oxide—see above).

Composites having ratios of graphene oxide to activated carbon of 10:1, 1:1 and 1:20 were also prepared.

Where the reduced graphene oxide was present in excess or equal weight, such as where the ratio of graphene oxide to activated carbon was 10:1 or 1:1, the electrochemical performance of the resulting capacitor was reduced compared with the 1:10 composite.

Where the activated carbon was in large excess, such as where the ratio of graphene oxide to activated carbon was 1:20, the binding between the current collector and the electrode layer was poor, as was the binding between activated carbon particles.

Additional solvent (propylene carbonate) may be added after mixing to control the viscosity of the mixture. The solvent may be added stepwise until the required viscosity is acquired.

Alternative polar solvents may be use in place propylene carbonate, so long as the solvent can dissolve and exfoliate graphene oxide/graphite oxide, and can be evaporated completely at or below 300° C. without contaminating the composite.

Example polar solvents include water, methanol, ethanol, acetone, tetrahydrofuran (THF), dimethylformamide (DMF), N-methylpyrrolidone (NMP), dimethyl sulfoxide (DMSO), and ethylene glycol, and mixtures thereof, including mixtures with propylene carbonate.

The mixture of graphene oxide and activated carbon in propylene carbonate was sonicated for around 1 h. (although sonication times may be varied as required).

The sonicated mixture was then coated onto a current collector, using a doctor blade or bar coater. The mixture may be coated onto one surface of the current collector, or on two opposing surface thereby to sandwich the current collector between layers of composite material.

An Al foil having a 2 micron chemical resistant conductive coating on one side was used as the current collector (the total foil thickness 27 micron). The composite material was coated on the Al foil surface which has the conductive coating.

The coated current collector was then dried in a vacuum at 60° C. (10 kPA in a vacuum oven). Here, the propylene carbonate solvent, contained in the electrode material layer, is removed by evaporation. At this temperature solvent decomposition is not observed, and this is beneficial as solvent decomposition will leave contaminating by-products within the final composite material.

It is also possible to dry the composite in a drying oven by simple ventilation drying. Here, higher temperatures are required to remove the propylene carbonate solvent. The use of a vacuum oven is preferred, as temperatures may be minimised for the solvent removal. High temperatures combined with high vacuum levels are to be avoided in order to prevent damage to the electrode layer e.g. due to rapid solvent evaporation.

There is no particular limitation on the nature of the atmosphere in the vacuum oven. However, an inert atmosphere or nitrogen or argon may be used.

To make the electrode material, either graphene oxide or graphite oxide can be mixed with activated carbon. Graphite oxide is converted to graphene oxide by ultrasonication. However after mixing graphene oxide with activated carbon in the polar solvent, the mixture is sonicated again for further exfoliation of graphene oxide and to obtain a homogeneous mixture. Therefore at the beginning, graphite oxide can be directly mixed with activated carbon, as it will be converted to graphene oxide during the sonication of the mixture.

To make a composite, the coated backing plate is heated to 300° C. under an inert atmosphere (N₂ or Ar), thereby to reduce the graphene oxide within the material.

Generally, the reduction temperature of the composite must be maintained at no more than 300° C., and the heating time should generally not exceed 1 h., and 30 min. is preferred. The reduction reaction was performed under at 1 kPA vacuum.

If higher temperatures, longer heating times or higher vacuum levels are used, rapid thermal expansion of the GO is observed, causing the composite to expand. A comparative temperature study is described in further detail below in relation to the use of graphene oxide alone.

At lower temperatures, the reduction level of graphene oxide is lower, hence the conductivity of the resulting composite is also lower.

Conductivity and adhesion are optimised at the conditions discussed above.

It is possible that some oxide functional groups in the graphene oxide are not entirely released, and may remain in the reduced graphene oxide. Thus, the reduced graphene oxide may have some, typically small, level of oxide functionality.

Analysis of Carbon Composite

The composite was analysed by FTIR, SEM, XRD and Raman spectroscopy. The SEM images were obtained for a composite on the Al foil backing plate. The remaining analyses were conducted on composite alone (i.e. not on a backing plate).

The reduced graphene oxide is dispersed throughout the electrode material in such a way as to wrap the activated carbon particles. Layers of reduced graphene oxide makes surface contact with a plurality of activated carbon particles. Within the composite the reduced graphene oxide layers are connected to each other and form a network for electric conduction.

The overlap of peaks in FTIR spectra of reduced graphene oxide and activated carbon makes it difficult to distinguish peaks corresponding to each material (see FIG. 7).

The SEM images of the carbon composite show reduced graphene oxide layers covering the surface of activated carbon particles. The layers are also in surface contact with each other forming a three dimensional network throughout the composite. No “unwrapped” activated carbon particles were observed, suggesting a high surface coverage by reduced graphene oxide layers.

It was observed that the activated carbon pores are not blocked by reduced graphene oxide. The high magnification images demonstrate thin, film like reduced graphene oxide layers transparent to electrons. The absence of charging during the SEM imaging indicates that the network of reduced graphene oxide/activated carbon is electrically conductive. This is further confirmed by DC electrical measurements (see the comments below regarding the electrochemical characterisation).

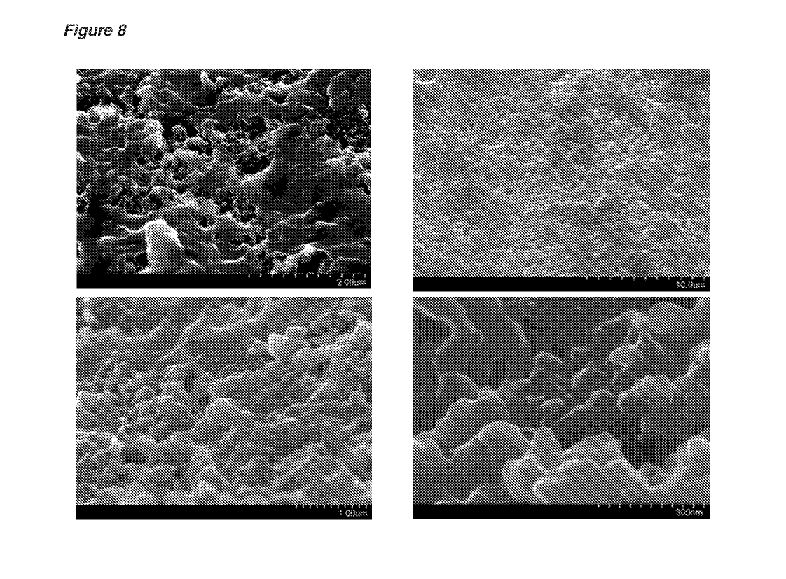

The SEM images are set out in FIG. 8 for a range of different magnifications.

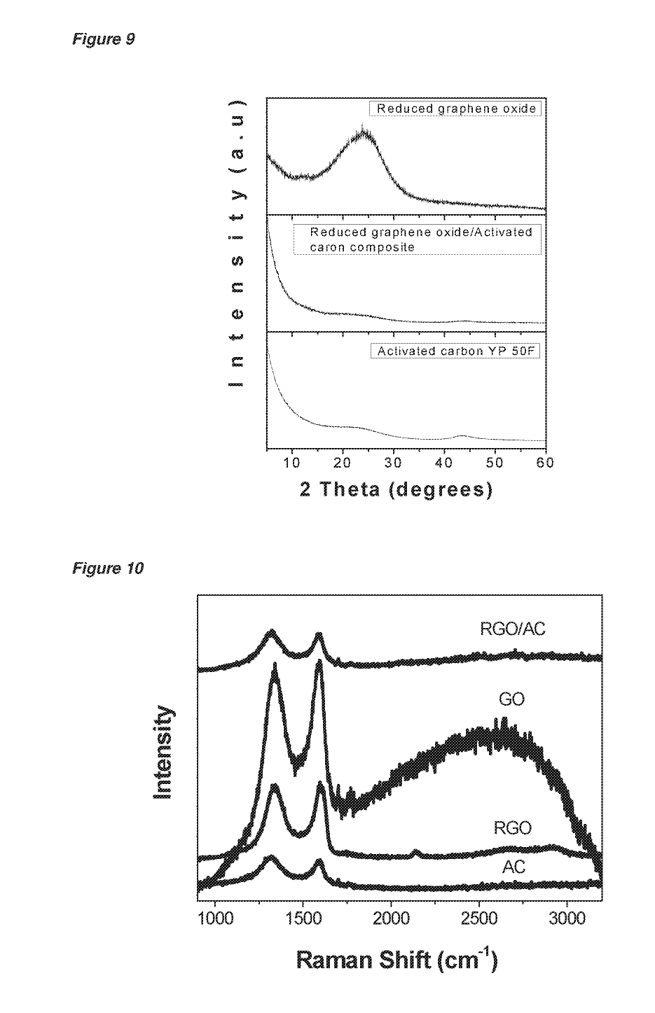

XRD spectra are shown in FIG. 9, where (a) is the spectrum for reduced graphene oxide; (c) is the spectrum for activated carbon; and (b) is the spectrum for a composite of reduced graphene oxide and activated carbon composite. The XRD spectrum of the composite (b) is given with the XRD spectra of the individual components (a) and (c) for comparison.

The most intensive peak for graphene oxide is at around 2θ=11.2°, corresponding to an interlayer distance of 0.79 nm and to the (002) reflection See FIG. 2). For reduced graphene oxide (FIG. 9 A), this peak shifts to 2θ=23.92° (0.37 nm) upon reduction of graphene oxide (at 300° C. in this case) due to the removal of oxygen-containing functional groups on the graphite sheets.

The diffraction peaks of reduced graphene oxide/activated carbon composite (B) are similar to those of activated carbon (C), where the (002) reflection peak of layered reduced graphene oxide has almost disappeared. The diffraction peaks for reduced graphene oxide disappear from the XRD pattern of the composite, confirming that the reduced graphene oxide within the composite is well exfoliated and they are not in the form of their regular stacks.

There is often little difference in the Raman spectra of reduced graphene oxide and activated carbon, making it difficult to distinguish peaks corresponding to each material in the Raman spectrum of their composite. However, the broad peak in the 2,000-3,000 cm⁻¹ region in the Raman spectrum of graphene oxide, disappears from that of the composite. This indicates that graphene oxide is reduced to reduced graphene oxide under the applied conditions.

The Raman spectra for graphene oxide, reduced graphene oxide, activated carbon and the composite are shown in FIG. 10.

Preparation of Coin-Shaped Supercapacitor (Supercapacitor A)

A coin-shaped capacitor in the form a supercapacitor was prepared from the carbon composite provided on the Al foil current collector.

Thus, as prepared composites are cut into discs of required size, and two such discs are required for a capacitor, with each disc acting as a separate electrode.

In an exemplary construction, CR2032 type cell cases, made of 304 stainless steel with a sealing O-ring, were used to construct a coin-shaped supercapacitor. The supplier was MTI Corporation.

A composite as prepared according to the method above, was stamped into discs with a diameter of 14 mm. Subsequently, the disc shaped electrodes were dried under reduced pressure in a vacuum oven at 110° C. overnight. The exact drying time depends on the amount of electrode material. The electrode is dried until the electrode reaches a constant mass. This drying step allows for the removal of moisture trapped in the electrode material layer. The vacuum oven was typically operated at a vacuum pressure in the range 100 to 500 mbar (10 kPa to 50 kPa). The pressure was selected to ensure that the composite was not removed from the backing plate under the drying conditions.

To prepare a coin-shaped supercapacitor two disc electrodes are placed either side of a separator. The composite-coated side of the electrode faces the separator. Two stainless steel spacers are provided against the others sides of each disc electrode, and stainless steel wave springs are provided against each stainless steel spacer. The uncoated surface of the electrode faces the stainless steel spacers. This stacked assembly is provided within enclosing bottom and top cases. The bottom case is provided a sealing O-ring. The bottom and top cases were subjected to pressure bonding, for example with crimper sealing at 800 to 1,000 psi (ca. 5,515 kPa to 6,894 kPa).

The assembly process was carried out in a nitrogen-filled glovebox with oxygen and moisture levels of <1 ppm.

The two cell cases are insulated from each other, and sealed by the sealing O-ring, which is typically polypropylene or the like. Within the coin type supercapacitor, one electrode is in electrical contact with the top case via physical contact with a first spacer, and the other electrode is in electrical contact with the bottom case via physical contact with a second spacer. It is the Al foil of the electrode that is in physical contact with the stainless steel spacers, and not the composite.

The separator is an insulating material and may be selected from materials such as cellulose, glass fibres, polyethylene and polypropylene. The separator may be in the form of a paper (sheet), a membrane and the like. The separator is ion permeable.

In the exemplary coin-shaped supercapacitor a cellulose paper (180 μm thick) was used. Thus, a Whatmann No. 1 filter paper made of cellulose filters was stamped in to a circular shape with a diameter of 18 mm before assembly in to the coin cells.

The separator is soaked with an electrolyte solution. In the exemplary coin-shaped supercapacitor 1 M solution of TEABF₄ in propylene carbonate was used as the electrolyte solution. Other electrolytes may be used, and many other electrolytes, such as solution and solid electrolytes are known in the art. A sufficient amount of electrolyte solution was added to soak the separator and the two electrodes, without flooding the device.

Comparative Supercapacitors

The example supercapacitor comprises electrodes having a composite that comprises reduced graphene oxide and activated carbon (YP50F).

For comparison three additional supercapacitors were prepared.

The first comparative supercapacitor included electrodes having a composite comprising activated carbon (YP50F) and sodium carboxy methyl cellulose (CMC), a conventional binder, which is use in place of reduced graphene oxide.

The second comparative supercapacitor included electrodes having a composite comprising activated carbon (YP50F) and sodium carboxy methyl cellulose (CMC), and carbon black (CB).

The third comparative supercapacitor included electrodes having a composite comprising a reduced graphene oxide (RGO) film obtained by reducing graphene oxide (GO) under the same reduction conditions used for the preparation of reduced graphene oxide in the composite in the worked example of the invention.

The composite in each comparative example was provided on an Al current collector. Here, as before, an Al foil was used with a 2 μm chemical resistant conductive coating on one surface. The total thickness of the current collector was 27 μm. The composite was coated onto the surface of the foil with the chemical resistant conductive coating.

First Comparative Supercapacitor (Supercapacitor B)

Sodium carboxy methyl cellulose (CMC) (average M_{w}˜90,000, from Sigma Aldrich) was used as a binder for fabricating the electrode of the first comparative supercapacitor.

CMC and activated carbon (YP50F) were added to deionized water and were mixed. The ratio of CMC to activated carbon was set to 1:10 by weight. The viscosity of the mixture was adjusted by addition of further deionized water until the required viscosity was acquired. Deionized water was used as the solvent for the reason that CMC is readily soluble in water.

Next, the mixture was coated over the chemical resistant conductive coating side of the Al current collector using a doctor blade or a bar coater.

The coating mixture on the current collector was dried in a vacuum oven at a temperature of 110° C. and a pressure of 100 mbar. In this step, the deionized water, contained in the electrode material layer was removed by evaporation. There is no particular limitation on the atmosphere. High temperatures and very low pressures were avoided to prevent damage to the electrode layer owing to rapid solvent evaporation.

It is also possible to dry the composite in a drying oven by simple ventilation drying. Higher drying temperatures may be used.

The prepared electrodes were cut into discs for incorporation into CR2032 type cell cases.

The first comparative supercapacitor was prepared in the same manner as the exemplary supercapacitor of the invention.

Second Comparative Supercapacitor (Supercapacitor C) Sodium carboxy methyl cellulose (CMC) (average M_{w} ˜90,000, from Sigma Aldrich) was used as a binder and Carbon black (CB) (from Cabot Corporation) were used for fabricating the electrode of the second comparative supercapacitor.

CMC, CB and activated carbon (YP50F) were added to deionized water and were mixed. The ratio of CMC to CB to activated carbon was 1:1:10 by weight. The viscosity of the mixture was adjusted by addition of further deionized water until the required viscosity was acquired.

Next, the mixture was coated over the chemical resistant conductive coating side of the Al current collector using a doctor blade or a bar coater. The mixture was dried as described above in relation to the first comparative supercapacitor.

The prepared electrodes were cut into discs for incorporation into CR2032 type cell cases. The second comparative supercapacitor was prepared in the same manner as the exemplary supercapacitor of the invention.

Third Comparative Supercapacitor (Supercapacitor D)

A graphene oxide film was synthesised by the variation of Hummers' method (described before). The film was mixed with propylene carbonate and coated onto over the chemical resistant conductive coating side of the Al backing plate, and subsequently dried and reduced in the same manner as the composite for use in the present invention.

The prepared electrodes were cut into discs for incorporation into CR2032 type cell cases. The third comparative supercapacitor was prepared in the same manner as the exemplary supercapacitor of the invention.

Electrochemical Characterisation of Capacitors

Coin-type supercapacitor cells, prepared as described above, were electrochemically characterized by cyclic voltammetry (CV), galvanostatic charge-discharge cycling and Frequency Response Analysis, using an Autolab electrochemical interface instrument (PGSTAT 302N).

A two-electrode test fixture was used in all electrochemical measurements.

CV was used to observe the variation in capacitance with the scan rate. With CV curves, capacitance depends on scan rate, voltage range, and computation method. The test cells were cycled between −2.5 V to +2.5 V at different scan rates (50, 100, 200, 300, 400, 500, 600, 700, 800, 900, 1000 and 1500 mV/s) and the specific capacitance (Csp) was determined based on the mass of the electrode material.

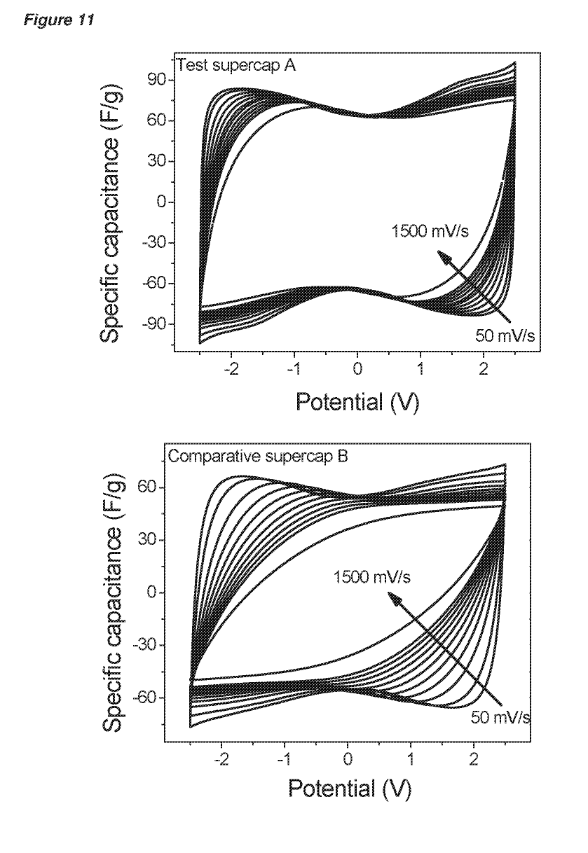

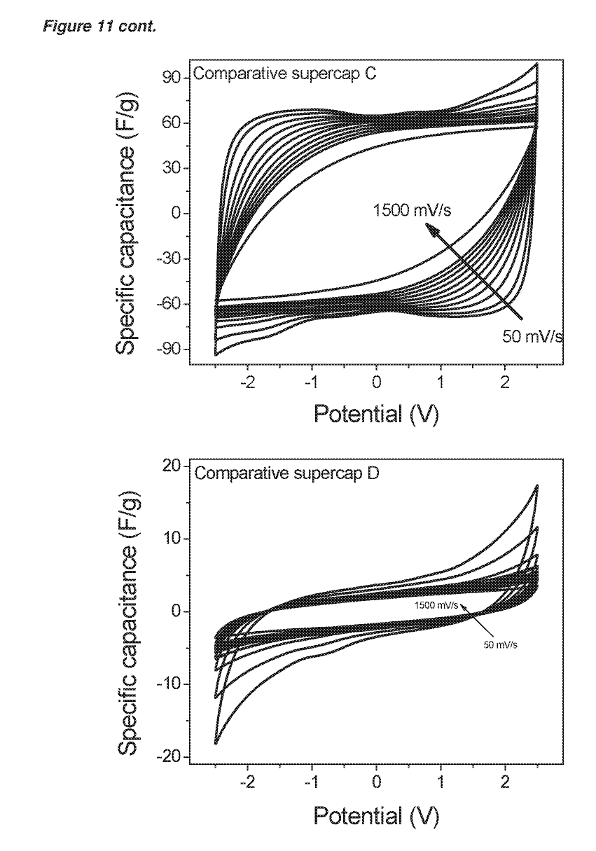

FIG. 11 shows CVs for the exemplary supercapacitor of the invention (Supercapacitor A), and the comparative supercapacitors (B, C and D). The supercapacitors were cycled between −2.5 V to +2.5 V at scan rates 50, 100, 200, 300, 400, 500, 600, 700, 800, 900, 1,000 and 1,500 mV/s.

The supercapacitor of the invention (supercapacitor A) showed near-rectangular CV curves at all scan rates from 50 to 1500 mV/s indicating small mass transfer resistance and good charge propagation behaviour of ions in the electrode. However, for the comparative supercapacitors B and C, the CV curve distorts markedly as the scan rate increases. For the comparative supercapacitor D, as the scan rate increases, although the total capacitance decreases, the shape of the curve improves. This indicates kinetically slow Faradaic reactions occurring on the electrode surface.

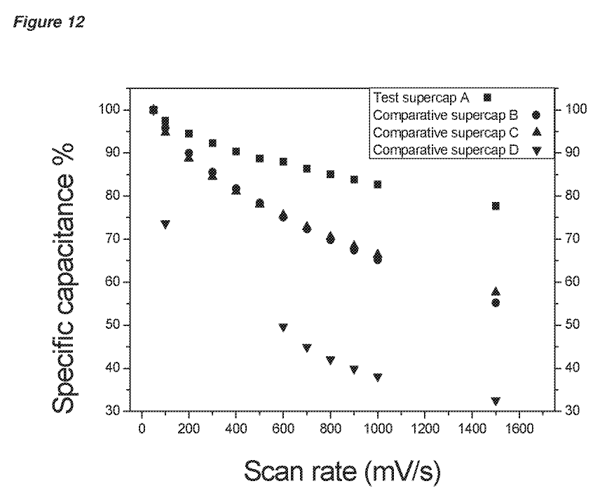

FIG. 12 shows the variation of the specific capacitance with the scan rate for the supercapacitor of the invention (supercapacitor A), and comparative supercapacitors B, C and D cycled between −2.5 V to +2.5 V. Here, the specific capacitance of each device at different scan rates is given as a percentage of specific capacitance of that device at 50 mV/s. As the scan rate increases from 50 mV/s to 1500 mV/s, for the supercapacitor of the invention (supercapacitor A), specific capacitance only decreased slightly by 22.3%, while for the comparative supercapacitors B, C and D it decreases by 44.8%, 42.4% and 67.5% respectively.

Galvanostatic charge-discharge measurements were used to observe the variation in capacitance with the applied current density and to calculate the equivalent series resistance (ESR). The supercapacitors were cycled between 0 V to +2.5 V at different current densities (2, 3, 4, 5 A/g) and the specific capacitance (Csp) was determined based on the mass of the electrode material.

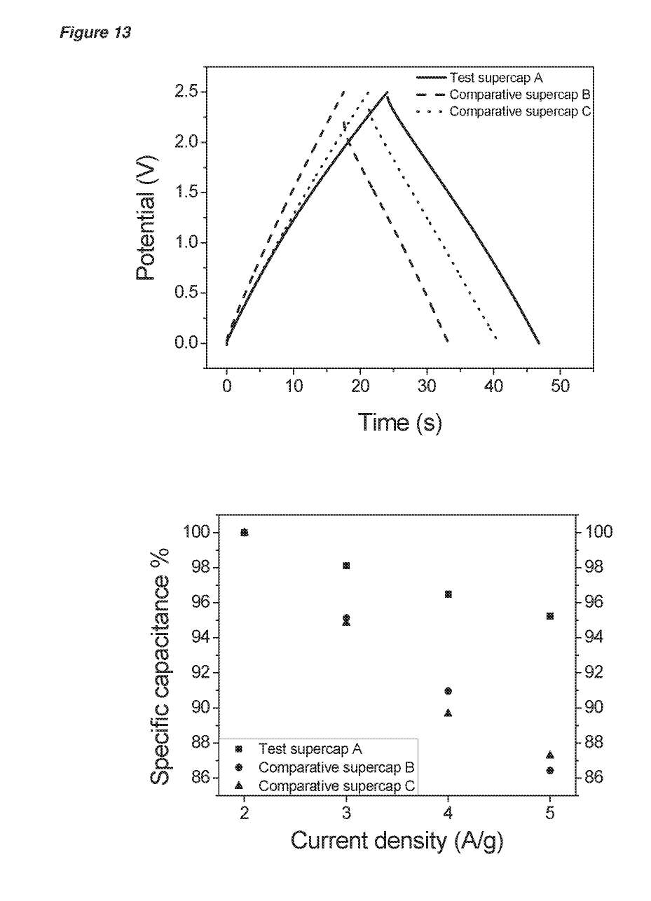

FIG. 13 shows galvanostatic charge-discharge curves for the supercapacitor of the invention (supercapacitor A), and comparative supercapacitors B and C cycled between 0 V to +2.5 V at current density 2 A/g. Since the specific capacitance of the comparative supercapacitor D was very low, a charge discharge curve at 2 A/g was not recorded for that cell.

The specific capacitance of the devices, at 2 A/g, were 79.8 F/g for the supercapacitor of the invention (supercapacitor A), 57.5 F/g for the comparative supercapacitor B and 66.0 F/g for the comparative supercapacitor C. Also, charge/discharge curves for the supercapacitor of the invention (supercapacitor A) shows the smallest IR drop and hence the lowest ESR, further indicating an ideal electrochemical double layer formation within the reduced graphene oxide/activated carbon composite electrode structure.

FIG. 13 also shows the variation of the specific capacitance with the current density for the supercapacitor of the invention (supercapacitor A), and comparative supercapacitors B and C cycled between 0 V to +2.5 V. Here, the specific capacitance of each device at different scan rates is given as a percentage of specific capacitance of that device at 2 A/g. The measurements were taken at current densities 2, 3, 4, 5 A/g.

As the current density increases from 2 A/g to 5 A/g, for the supercapacitor of the invention (supercapacitor A), specific capacitance only decreased slightly by 4.8%, while for the comparative supercapacitors B and C it decreases by 13.6% and 12.8% respectively.

At 5 A/g, the supercapacitor of the invention (supercapacitor A) shows a high power density of about 134 kW/kg with an energy density of 17 W h/kg.

Frequency Response Analysis (FRA) was carried out in the range of 0.01 Hz to 100,000 Hz with a DC bias of 10 mV, to further understand the superior power performance of the reduced graphene oxide/activated carbon composite electrodes. The total resistance of the device and the resistive component due to the electrode material was extracted from the data.

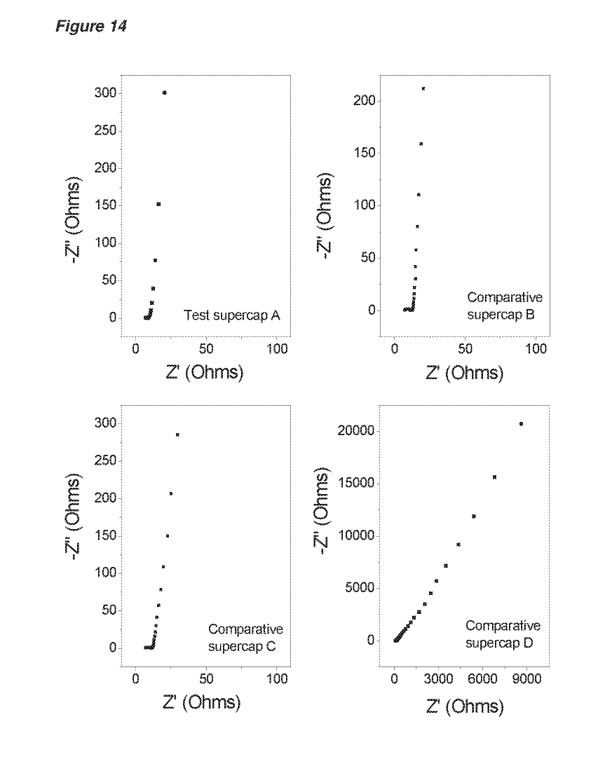

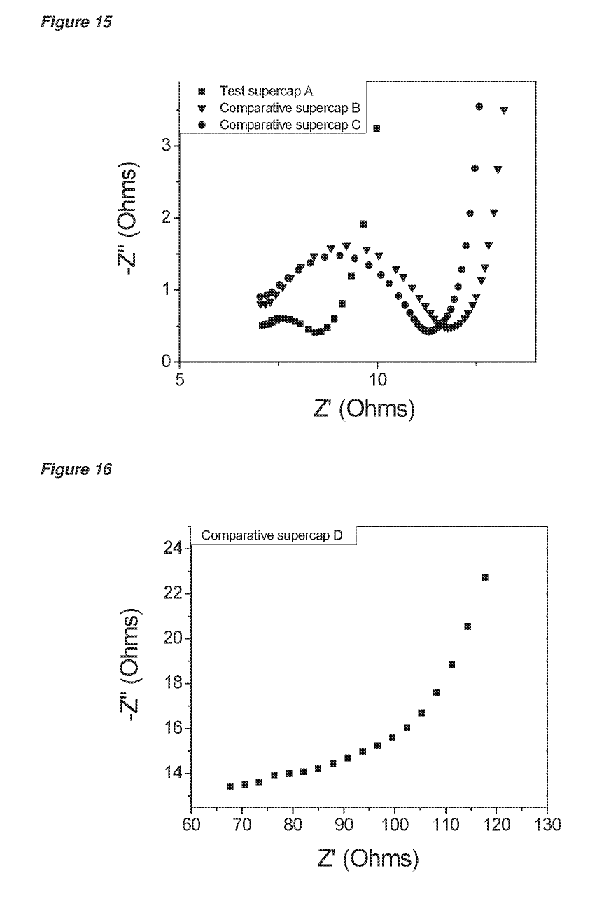

FIG. 14 shows the obtained Nyquist plots for the supercapacitor of the invention (supercapacitor A), and comparative supercapacitors B, C and D. Expanded views of the high frequency region for the supercapacitor of the invention (supercapacitor A), and comparative supercapacitors B and C are shown in FIG. 15, and comparative supercapacitor D is shown in FIG. 16.

The supercapacitor of the invention (supercapacitor A) gives the smallest high-frequency resistor-capacitor (RC) loop or semicircle, indicating good electrode contact, with good ion response.

From the cyclic voltammetry, galvanostatic charge discharge measurements and frequency response analysis it is clear that the supercapacitor of the invention (supercapacitor A) shows excellent electrochemical characteristics compared to comparative supercapacitors B and C.

This is seen from the higher specific capacitance, energy density, power density and lower equivalent series resistance (ESR). This indicates an efficient electrochemical double layer formation within the reduced graphene oxide/activated carbon composite electrode structure, even at very high scan rates or high current densities. This is attributed to the highly interconnected 3D structure and short diffusion pathways of the composite electrode favouring fast charge transportation. Reduced graphene oxide layers, as the conductive binder, make surface contact with activated carbon particles and they are also in surface contact with each other forming a three dimensional network, attached to the current collector.

This favourable structure cannot be achieved in the electrodes of comparative supercapacitor B, in which binder is a nonconductive polymer (CMC) and also in the electrodes of comparative supercapacitor C, in which binder is a nonconductive polymer (CMC) and the conductive additive is carbon black particles, which makes point contact with activated carbon.

Also, unlike reduced graphene oxide in the supercapacitor of the invention (supercapacitor A), CMC and carbon black do not contribute to the total capacitance. Since the surface area of reduced graphene oxide layers is involved in charge storage and contributes to the total capacitance, the proportion of electrochemically active material within the electrode of the supercapacitor of the invention (supercapacitor A) is higher, and hence the capacitance is higher, compared with comparative supercapacitors B and C.

Compared to the comparative supercapacitor B, the supercapacitor of the invention (supercapacitor A) shows:
an increase in specific capacitance in the range 25-40%;
an increase in energy density in the range 25-40%; and
a 4-5 fold increase in power density.

Compared to the comparative supercapacitor C, the supercapacitor of the invention (supercapacitor A) shows:
an increase in specific capacitance in the range 10-20%;
an increase in energy density in the range 10-20%; and
a 3-4 fold increase in power density.

Reduced graphene oxide/activated carbon composite electrode showed excellent cycling performance, and ˜80% capacitance retention was experimentally observed after 20,000 cycles. This indicates a very stable electrode material. Replacing conventional conductive particles and nonconductive polymeric binders with conductive reduced graphene oxide improves the supercapacitor cycling lifetime.

From the cyclic voltammetry and the frequency response analysis, it is clear that the specific capacitance of comparative supercapacitor D is very low (5.6 F/g) and the ESR is very high (67 ohms). This can be attributed to restacking of the reduced graphene oxide layers during the reduction reaction, as shown by the XRD of the reduced graphene oxide. Restacking of layers reduces the accessible surface area for the ions for double layer formation and this reduces the specific capacitance. Under the reduction conditions used in this work, graphene oxide does not become conductive enough to show lower ESR values as an electrode material itself.

However, when comparing with the electrochemical performance of the supercapacitor of the invention (supercapacitor A), in which reduced graphene oxide act as the conductive binder, it is clear that the reduced graphene oxide/activated carbon composite electrode exhibits an improved electrochemical performance as compared to its individual components reduced graphene oxide or activated carbon. This improvement can be attributed to the synergistic effect of reduced graphene oxide and activated carbon

In the methods of the invention it seems that the controlled heating of graphene oxide with the active material (such as activated carbon, such as in an inert atmosphere at 300° C./10 mbar for less than 1 hr) is important, as it prevents restacking of graphene oxide layers during reduction, and thereby gaining the useful conductive and binder properties of the reduced graphene oxide.

Reduction Temperature Effect on Conductivity

At lower treatment temperatures, the reduction of graphene oxide is lower, hence the conductivity of the composite is lower. This is seen when reducing as prepared graphene oxide films at different temperatures, preparing coin-type supercapacitors from those films and carrying out Frequency Response Analysis (FRA) of the supercapacitors.

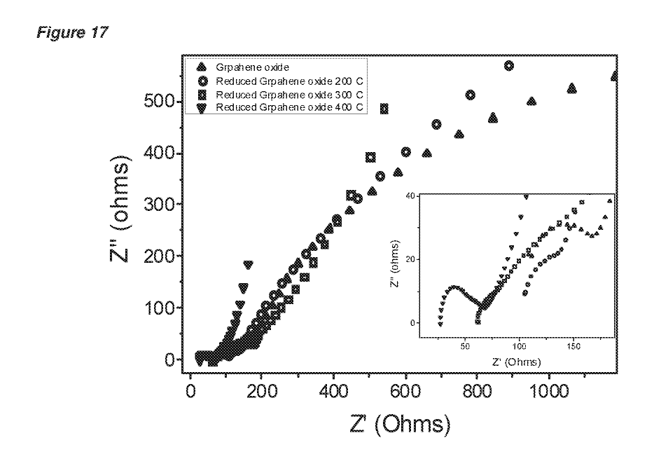

The Nyquist plots obtained by frequency response analysis (FRA) are shown in FIG. 17.

The Nyquist plots were obtained for coin cell type supercapacitors using an electrode having a graphene oxide film, an electrode having an activated carbon/graphene oxide composite reduced at 200° C. (10 mbar pressure/inert atmosphere/30 min); an electrode having an activated carbon/graphene oxide composite reduced at 300° C. (10 mbar pressure/inert atmosphere/30 min); and an electrode having an activated carbon/graphene oxide composite reduced at 400° C. (10 mbar pressure/inert atmosphere/30 min).

These Nyquist plots were obtained by making coin cell type supercapacitors using (i) graphene oxide film synthesised by the method described (variation of Hummers' method); (ii) a graphene oxide film reduced at 200° C. (10 mbar pressure/inert atmosphere/30 min); (iii) a graphene oxide film reduced at 300° C. (10 mbar pressure/inert atmosphere/30 min); and (iv) a graphene oxide film reduced at 400° C. (10 mbar pressure/inert atmosphere/30 min).

Only the reduction temperature was varied between the final three examples. All the other reduction conditions are as same as those for the activated carbon/graphene oxide composite electrode material.

The FRA measurements were undertaken in the same way as the activated carbon/reduced graphene oxide supercapacitor described above.

The Nyquist plots shows that as the graphene oxide is reduced and as the reduction temperature is increased:
(i) the intercept on the real axis (X axis) at the high frequency (dose to 100 kHz), (which represents the intrinsic internal resistance of the electrode material) shifts to lower values indicating that the internal resistance of graphene oxide is reduced upon thermal reduction and that of reduced graphene oxide reduces upon increasing reduction temperature;
(ii) the size of the semicircle at the high to mid frequency region (corresponding to the interfacial charge transfer resistance) reduces indicating that the charge transfer resistance of graphene oxide is reduced upon reduction and that of reduced graphene oxide reduces upon increasing reduction temperature; and
(iii) the line at low frequencies, become more parallel to the y axis and almost vertical indicating the improved capacitive performance upon reduction of graphene oxide and upon increasing reduction temperature.

From these observations it is clear that as the reduction temperature increases, the conductivity and the capacitive properties of reduced graphene oxide improves.

However for activated carbon/graphene oxide composites, the reduction temperature cannot be increased much above 300° C. as the electrode material layer detaches from the current collector. Therefore it is highly preferred that the reduction temperature is at most 450° C., such as at most 400° C., such as at most 350° C., such as at most 325° C.

### REFERENCES

All documents mentioned in this specification are incorporated herein by reference in their entirety.
Acik et al. J. Phys. Chem. C 115, 19761-19781 (2011)
Batalla Garcia et al. Renewable Energy 2011, 36, 1788
CN 103275368
CN 103515605
CN 103794379
CN 104064755
Dimiev et al. ACS Nano 7, 576-88 (2013)
Galhena et al. at Graphene 2014—Abstract—Graphene Oxide and Activated Carbon Composites for High-Power Supercapacitors
Galhena et al. at Graphene 2014—Poster—Reduced Graphene Oxide and Activated Carbon Composites for High-Power Supercapacitors
Gao et al. Nat. Chem. 1, 403-8 (2009)
Hummers et al. J. Am. Chem. Soc. 1958, 80, 1339
Marcano, D. C. et al. Improved synthesis of graphene oxide. ACS Nano 4, 4806-14 (2010)
Mermoux et al. Carbon N. Y. 29, 469-474 (1991)
Shim et al. ACS Appl. Mater. Interfaces 4, 4184-4191 (2012)
Szabó et al. Carbon N. Y. 44, 537-545 (2006)
Szabó et al. Chem. Mater. 18, 2740-2749 (2006)
US 2012/0321953
US 2014/0183415
US 2014/0340818
Wang et al. Electrochimica Acta 2010, 55, 6812
WO 2012/155196
Yan et al. Carbon 2010, 48, 3825
Yu et al. RSC Adv. 2014, 4, 48758
Zhu et al. Electrochimica Acta 2012, 64, 23

1.-26. (canceled)

27. A method for preparing a carbon composite, the method comprising the step of heating a mixture of graphene oxide and an active material at a temperature in the range 200 to 650° C.

28. The method of claim 27, wherein the active material is a carbon material.

29. The method of claim 28, wherein the carbon material is activated carbon.

30. The method of claim 27, wherein the temperature is in the range 250 to 350° C., such as about 300° C.

31. The method of claim 30, wherein the mixture is heated for at most 4 hours.

32. The method of claim 27, wherein the mixture was heated at reduced pressure, such as less than 101.3 kPa, such as 50 kPa or less.

33. The method of claim 27, wherein the mixture of graphene oxide and active material is provided on a backing plate, and the carbon composite is adhered to the backing plate.

34. The method of claim 33, wherein the backing plate is an electrically conductive backing plate.

35. The method of claim 34, wherein the backing plate is an aluminium backing plate.

36. The method of claim 27, wherein the weight ratio of graphene oxide to active material is in the range 1:1 to 1:25, such as 1:2 to 1:20.

37. The method of claim 36, wherein the weight ratio of graphene oxide to active material is about 1:10.

38. The method of claim 27, wherein the graphene oxide is obtained or is obtainable from graphite oxide.

39. The method of claim 27, wherein the graphite oxide is obtained or obtainable from graphite.

40. The method of claim 27, wherein the composite is substantially free of a nonconductive polymeric binder.

41. A carbon composite obtained or obtainable by a method according to claim 27.

42. An electrode comprising the carbon composite of claim 41.

43. The electrode of claim 42, which electrode is a component of capacitor.

44. The electrode of claim 42, which electrode is a component of a supercapacitor.
